(19) United States
(12) Patent Application Publication
(10) Pub. No.: US 2025/0378531 A1
(43) Pub. Date: Dec. 11, 2025

(54) METHODS AND SYSTEMS FOR DEMOSAICING A NON-BAYER COLOR FILTER ARRAY (CFA)

(71) Applicant: Samsung Electronics Co., Ltd., Suwon-si (KR)

(72) Inventors: Sarvesh Sarvesh, Bengaluru (IN); Yathish M REDDY, Bengaluru (IN); Addanki Sankara RAO, Bengaluru (IN); Siddharth Shreekumar SHARMA, Bengaluru (IN); Raj Narayana GADDE, Bengaluru (IN); Pravin Ramachandran NAIR, Bengaluru (IN); Daehun KIM, Suwon-si (KR); Dubok PARK, Suwon-si (KR); Jonghyun KIM, Suwon-si (KR); Junghyun PARK, Suwon-si (KR)

(21) Appl. No.: 19/252,585

(22) Filed: Jun. 27, 2025

Related U.S. Application Data
(63) Continuation of application No. PCT/IB2025/052663, filed on Mar. 13, 2025.

(30) Foreign Application Priority Data
Jun. 6, 2024 (IN) 202441044080
Nov. 29, 2024 (IN) 2024 41044080

(51) Int. Cl. G06T 3/4046; G06T 3/4015; G06T 5/60; G06T 7/90

(52) U.S. Cl. CPC G06T 3/4046; G06T 3/4015; G06T 5/60; G06T 7/90; G06T 2207/20084

(57) ABSTRACT

Methods and systems for providing a real time light weight non-Bayer color filter array (CFA) artificial intelligence (AI) demosaic through an architecture which leverages position dependent interpolation, position aware gradient, and light weight AI demosaic model are provided. The methods include position dependent interpolation and position aware gradient such that maximum information is preserved for efficient training of light weight deep neural network (DNN). The methods include producing high quality demosaic output from non-Bayer CFA image data without suffering from loss of details, texture and resolution power while maintaining low inference time.

### CROSS-REFERENCE TO RELATED APPLICATION(S)

This application is a continuation application, claiming priority under 35 U.S.C. § 365(c), of an International application No. PCT/IB2025/052663, filed on Mar. 13, 2025, which is based on and claims the benefit of an Indian Provisional application number 202441044080, filed on Jun. 6, 2024, in the Indian Patent Office, and of an Indian Complete patent application number 202441044080, filed on Nov. 29, 2024, in the Indian Patent Office, the disclosure of each of which is incorporated by reference herein in its entirety.

### TECHNICAL FIELD

The disclosure relates to the field of image processing. More particularly, the disclosure relates to methods and systems for obtaining a derived color image by demosaicing a non-Bayer color filter array (CFA).

### BACKGROUND ART

In a camera image signal processor (ISP) pipeline, demosaicing comprises converting a camera sensor format read into a perceptible linear red, green, blue (RGB) format, using a photoreceptor array.

FIG. 1 depicts a traditional image signal processor (ISP) pipeline according to the related art.

FIG. 2 depicts different color filter array (CFA) patterns according to the related art. The characteristic of a Bayer CFA include:
For every pixel position either green, red or blue is captured.
Capture pattern is a 2*2 block with 2 green, 1 red and 1 blue.
Common sensor pattern, found in most camera and ISP blocks.

In recent years, mobile original equipment manufacturers (OEMs) have moved on from a Bayer color filter array to a non-Bayer color filter array (CFA), such as quad-Bayer (tetra) CFA or nona CFA, etc. A non-Bayer CFA allows capture of high resolution images using a sensor of a size similar to a sensor used for a Bayer color filter array. In recent years, deep learning artificial intelligence (AI) models have outperformed traditional demosaic techniques with superior resolution and better structure reproduction in images. However, application of AI model for demosaic in non-Bayer CFA presents following challenges:
Due to smaller pixel size, raw data suffer from cross signal interference. This leads to a drop in resolution power during the demosaicing process.
For real time or near real time applications, the demosaicing operation has to be completed in order of milliseconds. This limits the demosaicing model's complexity. A shallow or less complex demosaicing model suffers from detail loss and smoothened textures.
Traditional AI demosaicing models do not use conditioned priors to guide the model to learn efficiently and faster. In addition, the conditioned priors should be fast to avoid problems of high latency which can render the solution undeployable.

Characteristic of a non-Bayer CFA include:
For every pixel position, either green, red or blue is captured.
Capture pattern is either 4*4, 6*6, and 8*8 block with sub pattern of 2*2, 3*3 and 4*4 block respectively.
Pixel sizes are usually smaller when compared with Bayer CFA.
Being useful in high resolution (>50 MP) sensing.

Existing AI models for demosaicing of non-Bayer data have the following challenges:

### 1) Imbalance Between Accuracy and Execution Time

Common data for demosaicing is either quad-Bayer or nona Bayer CFA. Existing demosaicing methods need to use computationally complex AI models because of the following challenges.
a) AI models has to learn to understand CFA patterns along with interpolating colors at individual pixels.
b) AI models also have to color interpolate ranging from 2 to 3 times as compared to Bayer CFA demosaicing.
c) For real time applications like capture, and video recording, complex models cannot be used due to high processing time. Further, light weight AI models are the way to go to complete ISP processing within a reasonable time.
d) Light-weight AI models for non-Bayer demosaicing even through faster results in a drop in resolution power, clarity, details and texture.

### 2) Loss of Details, Textures and Sharpness

Since the amount of interpolation in demosaicing of non-Bayer data to be performed is much higher than demosaicing of Bayer data, even with complex AI models, there is perceivable loss of details, textures and decrease in sharpness especially in case of objects at far distance.

FIG. 3 depicts understanding pattern and sub-blocks in non-Bayer CFA according to the related art.

FIG. 4A depicts a non-Bayer demosaicing method using a non-AI approach, according to the related art. In this approach, a rule based interpolation is used to estimate missing colors. However, the output suffers from color bleeding, broken edges, aliasing, and so on. Further, the output is obtained with low latency, but not useful in high resolution or detail capture scenario due to missing details and artefacts.

FIG. 4B depicts a non-Bayer demosaicing method using an AI model non-conditioning approach, according to the related art. Missing color values are interpolated using a raw CFA pattern. AI models can be complex and light. Learning bias is high due to heavy interpolation of missing colors. A complex AI model can retain details, but become unviable in near real time ISP due to high runtime. Further, A light weight demosaicing model, struggles to retain details and textures.

FIG. 4C depicts a non-Bayer demosaicing method using an AI model conditioning approach, according to the related art. Partial interpolated values are passed to the AI model. Missing color values are replaced with 0 at each pixel. Zero filling does not provide the necessary neighborhood information to the AI model for color interpolation. Light weight AI models with zero interpolation conditioning also struggle to retain details and textures.

FIG. 5 depicts example disadvantages of a non-Bayer CFAs, according to the related art. The non-Bayer CFAs require additional color interpolation in space which needs complex algorithms or deep learning models for retaining details and textures in an image. Complex algorithms or models cannot be deployed in near time on a device's ISP due to high latency. Additionally, light weight AI models tend to suffer from loss of details due to limited learning capability and absence of strong prior.

Traditional methods and systems are light weight due to near real time constraint of camera ISPs. The traditional methods suffer from low resolution power, loss of fine details and texture. AI models don't have strong priors and gradient information, and thus they are unable to efficiently map the learning space.

The above information is presented as background information only to assist with an understanding of the disclosure. No determination has been made, and no assertion is made, as to whether any of the above might be applicable as prior art with regard to the disclosure.

### SOLUTION TO PROBLEM

Aspects of the disclosure are to address at least the above-mentioned problems and/or disadvantages and to provide at least the advantages described below. Accordingly, an aspect of the disclosure is to provide methods and systems for providing real time light weight non-Bayer color filter array (CFA) demosaic which leverages a position dependent interpolation, a position aware gradient, and a light weight artificial intelligence (AI) demosaic model.

Another aspect of the disclosure is to provide schematic for position dependent interpolation and position aware gradient such that maximum information is preserved for efficient training of a light weight deep neural network (DNN).

Another aspect of the disclosure is to provide methods and systems for producing a high quality demosaic output from raw nonBayer CFA without suffering from loss of details, texture and resolution power, while maintaining low inference time.

Additional aspects will be set forth in part in the description which follows and, in part, will be apparent from the description, or may be learned by practice of the presented embodiments.

In accordance with an aspect of the disclosure, a method for demosaicing a non-Bayer CFA image data performed by an electronic device is provided. The method includes receiving as input, by at least one processor of the electronic device, a non-Bayer CFA image data from an image sensor of the electronic device, the non-Bayer CFA image data including a plurality of pixel blocks with individual pixel block having multiple colors of red, green, blue (RGB), and a plurality of sub-blocks with individual sub-block having uniform color, and the each sub-block being a sub-set of the pixel block. Further, the method includes, identifying, by the at least one processor, in the non-Bayer CFA image data, at least one recurrent pixel block following a common pixel pattern at a block level and a uniform color pattern at a sub-block level; estimating, by the at least one processor, for the at least one recurrent pixel block, a position dependent directional interpolation for computing a plurality of missing colors for each pixel in the at least one recurrent pixel block, based on, a number of neighboring pixels to the each pixel of the at least one recurrent pixel block, a direction of the neighboring pixels, and corresponding weights of interpolation for the number of neighboring pixels; generating, by the at least one processor, a position dependent interpolation feature map using the estimated position dependent directional interpolation; estimating, by the at least one processor, for the at least one recurrent pixel block, a position aware gradient for computing a rate of change of color for each pixel in the at least one recurrent pixel block, based on a number of neighboring pixels to the each pixel of the at least one recurrent pixel block, a direction of the neighboring pixels, and corresponding weights of gradient computation for the number of neighboring pixels; generating, by the at least one processor, a position aware gradient feature map using the estimated position aware gradient; and generating, by the at least one processor, an output RGB image data using a demosaic AI model, by feeding the generated position dependent interpolation feature map, and the generated position aware gradient feature map, and the non-Bayer CFA image data.

In accordance with another aspect of the disclosure, an electronic device is provided. The electronic device includes an image sensor, memory storing instructions, and at least one processor communicatively coupled to the image sensor and the memory. The instructions, when executed by the at least one processor individually or collectively, cause the electronic device to receive as input, non-Bayer CFA image data from the image sensor, the CFA image data including a plurality of pixel blocks with individual pixel block having multiple colors of RGB and a plurality of sub-blocks with individual sub-block having uniform color, and each sub-block being a sub-set of the pixel block, identify, in the non-Bayer CFA image data, at least one recurrent pixel block following a common pixel pattern at a block level and a uniform color pattern at a sub-block level, estimate, for the at least one recurrent pixel block, a position dependent directional interpolation for computing a plurality of missing colors for each pixel in the at least one recurrent pixel block, based on, a number of neighboring pixels to the each pixel of the at least one recurrent pixel block, a direction of the neighboring pixels, and corresponding weights of interpolation for the number of neighboring pixels, generate, a position dependent interpolation feature map using the estimated position dependent directional interpolation, estimate, for the at least one recurrent pixel block, a position aware gradient for computing a rate of change of color for each pixel in the at least one recurrent pixel block, based on a number of neighboring pixels to the each pixel of the at least one recurrent pixel block, a direction of the neighboring pixels, and corresponding weights of gradient computation for the number of neighboring pixels, generate, a position aware gradient feature map using the estimated position aware gradient, and generate an output RGB image data using a demosaic AI model, by feeding the generated position dependent interpolation feature map, and the generated position aware gradient feature map, and the non-Bayer CFA image data.

In accordance with another aspect of the disclosure, one or more non-transitory computer-readable storage media storing instructions that, when executed by at least one processor of an electronic device individually or collectively, cause the electronic device to perform operations, is provided. The operations include receiving as input, by the at least one processor, non-Bayer CFA image data from an image sensor of the electronic device, the non-Bayer CFA image data including a plurality of pixel blocks with individual pixel block having multiple colors of RGB, and a plurality of sub-blocks with individual sub-block having uniform color, and each sub-block being a sub-set of the pixel block; identifying, by the at least one processor, in the non-Bayer CFA image data, at least one recurrent pixel block following a common pixel pattern at a block level and a uniform color pattern at a sub-block level; estimating, by the at least one processor, for the at least one recurrent pixel block, a position dependent directional interpolation for computing a plurality of missing colors for each pixel in the at least one recurrent pixel block, based on, a number of neighboring pixels to the each pixel of the at least one recurrent pixel block, a direction of the neighboring pixels, and corresponding weights of interpolation for the number of neighboring pixels; generating, by the at least one processor, a position dependent interpolation feature map using the estimated position dependent directional interpolation; estimating, by the at least one processor, for the at least one recurrent pixel block, a position aware gradient for computing a rate of change of color for each pixel in the at least one recurrent pixel block, based on a number of neighboring pixels to the each pixel of the at least one recurrent pixel block, a direction of the neighboring pixels, and corresponding weights of gradient computation for the number of neighboring pixels; generating, by the at least one processor, a position aware gradient feature map using the estimated position aware gradient; and generating, by the at least one processor, an output RGB image data using a demosaic AI model, by feeding the generated position dependent interpolation feature map, and the generated position aware gradient feature map, and the non-Bayer CFA image data.

Accordingly, the various embodiments herein provide a method and system for producing high quality demosaic output from non-Bayer CFA image data without suffering from loss of details, texture and resolution power while maintaining low inference time.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 depicts an image signal processor (ISP) pipeline, according to the related art;

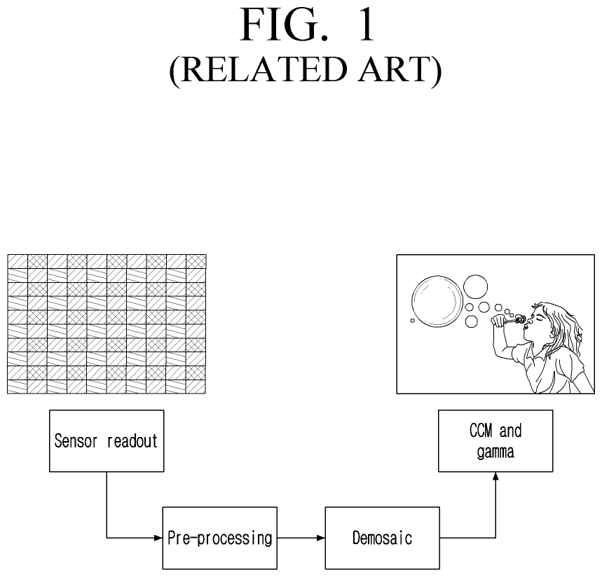

FIG. 2 depicts different example color filter array (CFA) patterns, according to the related art;

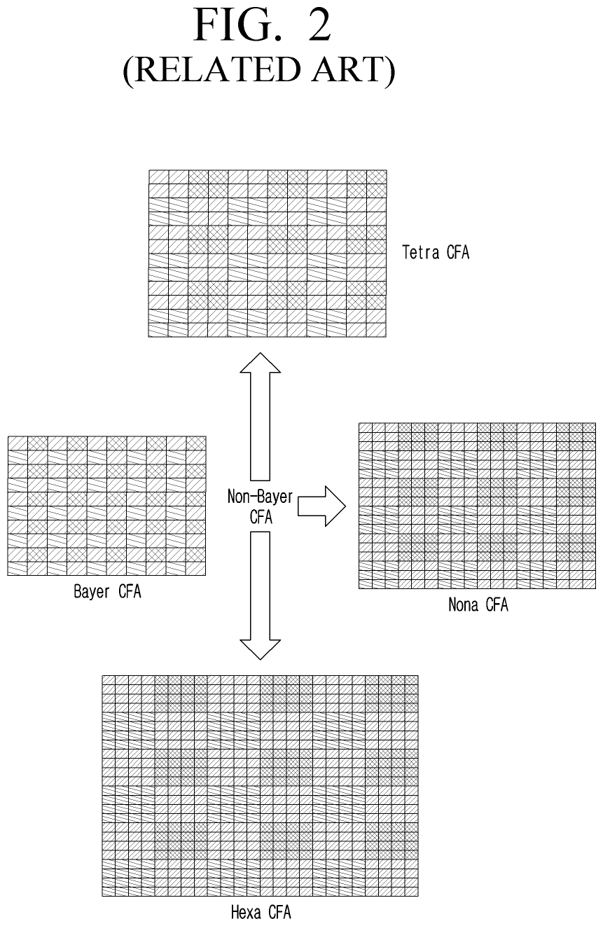

FIG. 3 depicts understanding pattern and sub-blocks in non-Bayer CFA, according to the related art;

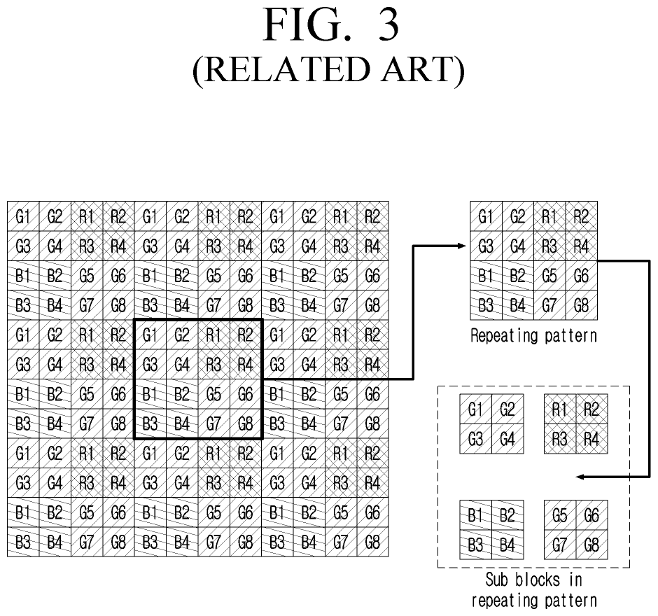

FIG. 4A depicts a non-Bayer demosaic method using a non-artificial intelligence (AI) approach, according to the related art;

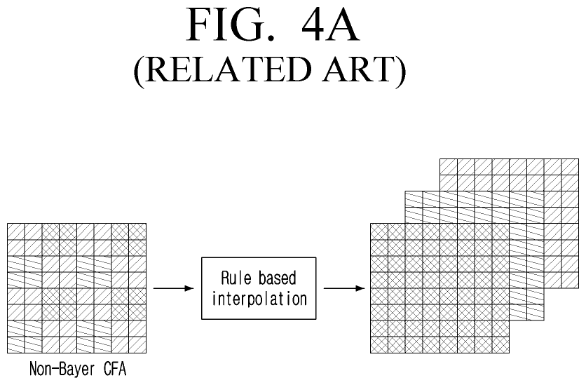

FIG. 4B depicts a non-Bayer demosaic method using an AI model non-conditioning approach, according to the related art;

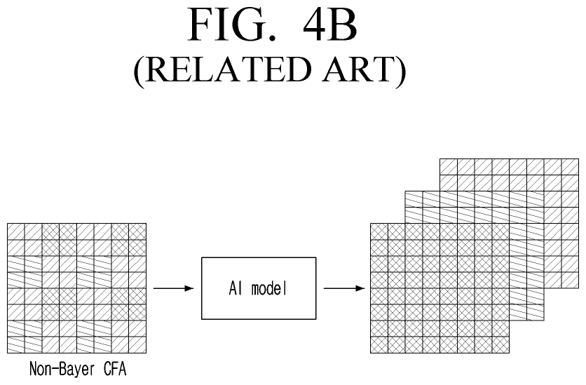

FIG. 4C depicts a non-Bayer demosaic method using an AI model conditioning approach, according to the related art;

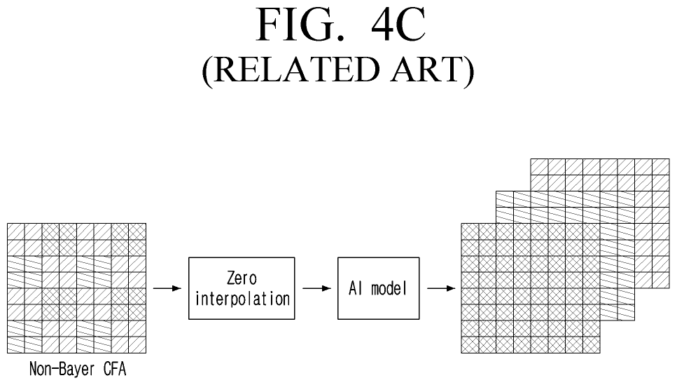

FIG. 5 depicts example disadvantages of a non-Bayer CFA, according to the related art;

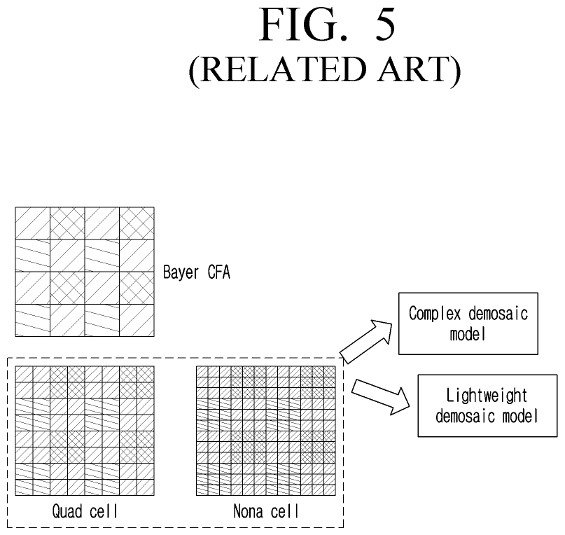

FIG. 6A depicts a block diagram of the system for demosaicing a non-Bayer CFA image, according to an embodiment of the disclosure;

FIG. 6B is a block diagram depicting interconnection between the plurality of sub components of a processor, according to an embodiment of the disclosure;

FIG. 7 depicts the flowchart of the method for demosaicing a raw non-Bayer CFA image, according to embodiments as disclosed herein, according to an embodiment of the disclosure;

FIG. 8 depicts an example demosaic architecture generation-directional interpolation schematic, according to an embodiment of the disclosure;

FIG. 9A depicts an example method for interpolating red using a horizontal direction for a sub block, according to an embodiment of the disclosure;

FIG. 9B depicts an example method for interpolating blue using a vertical direction for a sub block, according to an embodiment of the disclosure;

FIG. 10A depicts an example method for interpolating green using horizontal and vertical directions for a sub block, according to an embodiment of the disclosure;

FIG. 10B depicts an example method for interpolating blue interpolation using a diagonal direction for a sub block, according to an embodiment of the disclosure;

FIG. 11A depicts an example method for interpolating green interpolation using vertical and horizontal directions for a sub block, according to an embodiment of the disclosure;

FIG. 11B depicts an example method for interpolating red using a diagonal direction for a sub block, according to an embodiment of the disclosure;

FIG. 12A depicts an example method for interpolating red using a vertical direction, according to an embodiment of the disclosure;

FIG. 12B depicts an example method for interpolating blue using a horizontal direction, according to an embodiment of the disclosure;

FIG. 13 depicts an example demosaic architecture generation-gradient computation schematic, according to an embodiment of the disclosure;

FIG. 14A depicts an example method for computing a green gradient using 6*6 neighborhood window, according to an embodiment of the disclosure;

FIG. 14B depicts an example method for computing a red gradient using a 10*10 neighborhood window, according to an embodiment of the disclosure;

FIG. 14C depicts an example method for computing a blue gradient using a 10*10 neighborhood window, according to an embodiment of the disclosure;

FIG. 14D depicts an example method for computing a green gradient using a 6*6 neighborhood window for sub block 4, according to an embodiment of the disclosure;

FIG. 15A depicts an example demosaic architecture generation model, according to an embodiment of the disclosure;

FIG. 15B depicts an example on-device architecture generation algorithm, according to an embodiment of the disclosure;

FIG. 16A depicts an example high scale zoom capture (10×-100×), according to an embodiment of the disclosure;

FIG. 16B depicts an alternate example high scale zoom capture (10×-100×), according to an embodiment of the disclosure;

FIG. 16C depicts an example high resolution capture (50 MP), according to an embodiment of the disclosure;

FIG. 16D depicts an alternate example high resolution capture (50 MP), according to an embodiment of the disclosure; and

FIG. 16E depicts an example tetra zoom (10×-100×)capture, according to an embodiment of the disclosure.

Throughout the drawings, it should be noted that like reference numbers are used to depict the same or similar elements, features, and structures.

### DESCRIPTION OF EMBODIMENTS

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

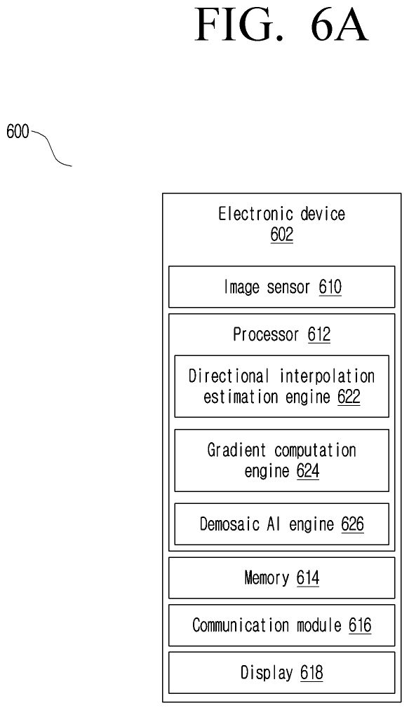

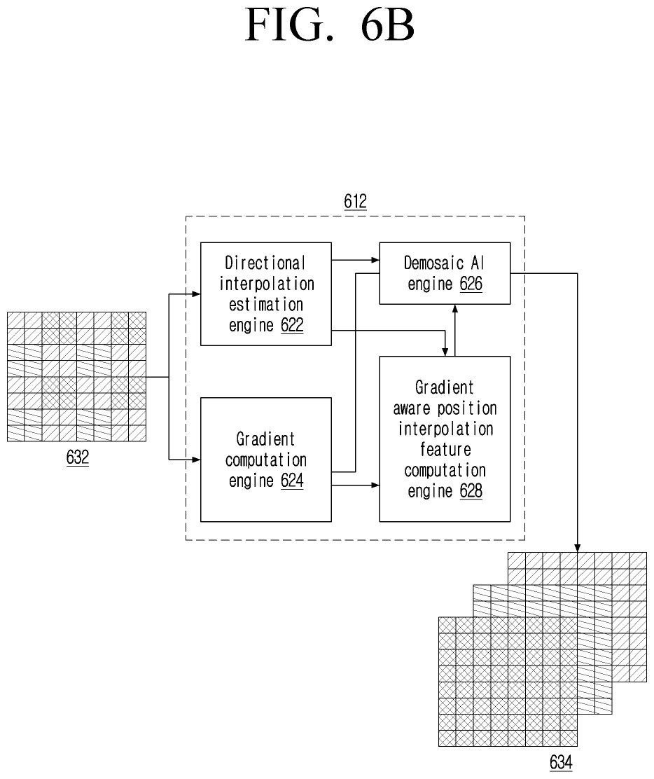

The embodiments herein provide methods and systems for a position dependent directional interpolation with gradient conditioning for demosaicing Non-Bayer color filter arrays (CFAs). Referring now to the drawings, and more particularly to FIGS. 6A, 6B, 7, 8, 9A, 9B, 10A, 10B, 11A, 11B, 12A, 12B, 13, 14A to 14D, 15A, 15B, 16A to 16D, where similar reference characters denote corresponding features consistently throughout the figures, there are shown embodiments.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 6A depicts the block diagram of the system (600) for demosaicing a non-Bayer CFA image, wherein the system (100) includes an electronic device (602), according to an embodiment of the disclosure.

The electronic device (602) can comprise a plurality of components such as, an image sensor (610), a processor (612), memory (614) and a communication module (616). Further, the processor (612) can comprise a plurality of sub-components such as, but not limited to, a directional interpolation estimation engine (622), a gradient computation engine (624) and a demosaic AI engine (626). In addition, the processor (612) may be communicatively coupled to each of the image sensor (610), the memory (614), and a communication module (616).

In an embodiment herein, the electronic device (602) can be an electronic device with communication facility. Further, in an embodiment herein, the electronic device (602) can be at least one of a digital image capturing device or an analog image capturing device. The electronic device (602) further, can be any device such as, but not limited to, an electronic equipment with communication facility designed to serve as a medium of facilitating virtual interaction with a real-world environment through one or more digital visual elements. Examples of the electronic device (602) can be, but not limited to, a phone with at least one camera, a portable computer with a camera, a web-enabled computing device with a camera, a stand alone digital camera, a tablet, a computer, a laptop, a wearable device, an Internet of Things (IoT) device, and so on.

The image sensor (610) can capture information of a region of interest (ROI) within a physical world. The image sensor (610) can comprise a mosaic of a plurality of tiny color filters (color filter array) for capturing color information from the ROI. In an embodiment herein, the image sensor (610) can be a charge couple device (CCD) image sensor, a complementary metal oxide semiconductor (CMOS) image sensor, a color type image sensor, rolling shutter type image sensor, a global shutter type image sensor, and so on, Further, the image sensor (610) can be characterized by frame rate, pixel size, sensor format, resolution and so on. In an embodiment herein, the color filter array (CFA) is a pattern of non-Bayer CFA, includes quad, nona, hexa, and other CFA patterns, which comprises of homogeneous color units in adjacent pixels repeatedly arranged in the image sensor (610).

The processor (612) of the electronic device (602) can receive the non-Bayer mosaic CFA from the image sensor (610). The processor (612) can perform demosaicing of the mosaic CFA in order to obtain a derived color image form the non-Bayer CFA. In an embodiment herein, the non-Bayer mosaic CFA includes a plurality of repeating patterns of a fixed block having multiple RGB color pixels, and a plurality of pre-defined number of sub-blocks present within the fixed block, wherein each sub-block of the plurality of sub-blocks has uniform color pixels. In an example embodiment herein, the processor (612) can generate a non-Bayer feature map, wherein the non-Bayer feature map comprises one or more features of the non-Bayer mosaic CFA.

In an embodiment herein, the processor (612) can comprise a directional interpolation estimation engine (622), a gradient computation engine (624) and a demosaic AI engine (626). Each of the directional interpolation estimation engine (622), the gradient computation engine (624) and the demosaic AI engine (626) are processes performed by the processor (612). Any number of the directional interpolation estimation engine (622), the gradient computation engine (624) and the demosaic AI engine (626) may be combined together or omitted. The directional interpolation estimation engine (622) can estimate a plurality of missing colors for each pixel in the non-Bayer feature map by using a position dependent directional interpolation for each pixel in the feature map. The gradient computation engine (624) can estimate a rate of change of color for each pixel in the non-Bayer feature map, using a position aware gradient for each pixel in the feature map. The demosaic AI engine (626) can generate a gradient aware position interpolation feature map by fusing a position dependent interpolation feature map, and a position aware gradient feature map. Further, the demosaic AI engine (626) can generate a derived RGB color image from the non-Bayer CFA and the gradient aware position interpolation feature map.

In an embodiment herein, the processor (612) can include at least one of analog or digital circuits such as, but not limited to, logic gates, integrated circuits, microprocessors, microcontrollers, memory circuits, passive electronic components, active electronic components, optical components, hardwired circuits and the like, and may optionally be driven by instructions such as firmware.

The processor (612) may further, include one or a plurality of processors. The one or any of the plurality of processors may be at least one of a general-purpose processor, such as a central processing unit (CPU), an application processor (AP), or the like, a field programmable gate array (FPGA), a graphics-only processing unit such as a graphics processing unit (GPU), a visual processing unit (VPU), or an AI-dedicated processor such as a neural processing unit (NPU). The one or any of the plurality of processors may include one or multiple cores, and may be configured to execute the instructions stored in the memory (614).

Further, the processor (612) is configured to execute instructions stored in the memory (614) and to perform various processes. The communication module (616) is configured for communicating internally between internal hardware components and with external devices via one or more networks. The memory (614) can also store instructions to be executed by the processor (612). The memory (614) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (614) may, in some examples, be considered a non-transitory storage medium. The term “non-transitory” may indicate that the storage medium is not embodied in a carrier wave or a propagated signal. However, the term “non-transitory” should not be interpreted that the memory (614) is non-movable. In certain examples, a non-transitory storage medium may store data that can, over time, change (e.g., in Random Access Memory (RAM) or cache). The processor (612), to perform the processes corresponding to each of the directional interpolation estimation engine (622), the gradient computation engine (624) and the demosaic AI engine (626), may execute one or more of the instructions stored in the memory (614). In case the processor (612) executes the one or more of the instructions stored in the memory (614) to perform the processes corresponding to each of the directional interpolation estimation engine (622), the gradient computation engine (624) and the demosaic AI engine (626), the processor (612) may use at least one of the analog or digital circuits when performing the processes corresponding to each of the directional interpolation estimation engine (622), the gradient computation engine (624) and the demosaic AI engine (626). In case the processor (612) executes the one or more of the instructions stored in the memory (614) to perform the processes corresponding to each of the directional interpolation estimation engine (622), the gradient computation engine (624) and the demosaic AI engine (626), the processor (612) may use at least one of the image sensor (610), the memory (614), or a communication module (616).

In an embodiment, the communication module (616) includes an electronic circuit specific to a standard that enables wired or wireless communication. The communication module (616) can be configured to communicate internally between internal hardware components of the electronic device and with external devices via one or more networks. In an example embodiment herein, the communication module (616) may include at least one of the Internet, a wired network (a local area network (LAN), a controller area network (CAN) network, a universal asynchronous receiver/transmitter (UART), a bus network, Ethernet and so on), a wireless network (a Wi-Fi network, a cellular network, a Wi-Fi hotspot, bluetooth, zigbee and so on, using wireless application protocol), a direct interconnection, and so on.

The electronic device (602) can include a display (618), to display the derived color image from the raw non-Bayer CFA image. In an embodiment herein, the display (618) can be a part of the electronic device (602). In another embodiment herein, the display (618) can be configured as a stand-alone display communicatively coupled with the electronic device (602) for displaying the color image.

FIG. 6B is the block diagram depicting interconnection between the plurality of sub-components of the processor (612), according to an embodiment of the disclosure.

A raw non-Bayer CFA image (632) is demosaiced by the processor (612). In an embodiment herein, upon obtaining the non-Bayer CFA image, the processor (612) can generate a non-Bayer feature map. The non-Bayer feature map comprises features of the non-Bayer CFA image representing repeating pixel blocks within the non-Bayer CFA image. Each repeating pixel block includes a pre-defined number of uniform color sub-blocks. A directional interpolation estimation engine (622) can perform demosaicing by first estimating a plurality of missing colors for each pixel in the non-Bayer feature map using a position dependent directional interpolation mechanism for each pixel. The demosaicing technique further includes obtaining a position dependent interpolation feature map from the position dependent directional interpolation mechanism. Further, a gradient computation engine (624) estimates the rate of change of color for each pixel in the non-Bayer feature map, using a position aware gradient for each pixel. The demosaicing technique further, includes obtaining a position aware gradient feature map using a gradient computation. In an embodiment herein, the demosaicing technique can include a gradient aware position interpolation feature computation engine (628) obtaining a gradient aware position interpolation feature map by combining the position dependent interpolation feature map and the position aware gradient feature map. The demosaicing technique further includes a demosaic AI engine (626) combining the position dependent interpolation feature map, the position aware gradient feature map and the non-Bayer CFA, in order to obtain the derived color-image (634) using at least, a deep neural network (DNN), and so on.

In an example embodiment herein, the subcomponents of the processor (612) can form a demosaic architecture generation module which is building a demosaic architecture based on a non-Bayer CFA pattern type. Further, in an embodiment herein, the demosaic architecture generation module comprises a directional interpolation engine, a gradient computation engine, a demosaic AI engine (which further includes a linear combination block (not shown), and at least one light weight DNN. The directional interpolation engine can generate the schematic for computing position specific direction interpolation. The gradient computation engine can provide a schematic for computing gradient values based on position of each pixel in recurring pattern. The linear combination block provides a schematic for combining directional interpolation and gradient values linearly. The light weight DNN can be an AI model which takes non-Bayer CFA, directional interpolation, gradient and their linear combination to generate a linear RGB output.

The demosaic architecture generation module can generate a trainable model, where the weights of the light weight DNN are learnable. Further, in an embodiment herein, the electronic device (602) can comprise an on-device architecture generation module (not shown) to convert the generated trainable model into a device optimal model by leveraging the schematic used in the demosaic architecture generation module.

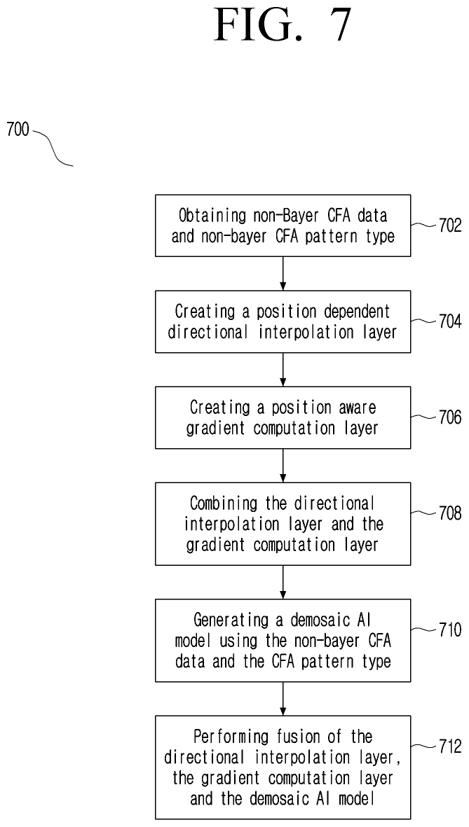

FIG. 7 depicts the flowchart of the method for demosaicing a raw non-Bayer CFA image, according to an embodiment of the disclosure.

The demosaic architecture generation module provides a trainable model which converts a raw non-Bayer CFA into a linear RGB data. The non-Bayer CFA type is provided to the demosaic architecture generation module to generate trainable model. The demosaic architecture generation module uses position dependent directional interpolation to create a custom operation (layer) which takes raw non-Bayer CFA and interpolates missing colors based on the position of a pixel in a fixed pattern and sub block. In an embodiment herein the fixed block is a recurrent pixel block following a common pixel pattern at block level and uniform color pattern at sub-block level. The demosaic architecture generation module uses a position aware gradient computation block to create a custom operation (layer) which takes raw non-Bayer CFA and generates color specific gradient based on a position of the pixel in the fixed pattern and sub block. In an embodiment herein, the schematic for gradient computation can be different for each color in the fixed pattern. The demosaic architecture generation module combines the directional interpolation and gradient to produce one or more gradient aware interpolated features from the raw non-Bayer CFA. In an embodiment herein, the one or more or more gradient aware interpolated features can include at least, one or more missing colors for each pixel in the fixed pattern, and rate of change of color for each pixel in the fixed pattern. The demosaic architecture combines a light weight DNN with directional interpolation, gradient and their combination to create a trainable model, where the weights of the light weight DNN are learnable. In an embodiment herein, the custom operations (layers) can be non-trainable.

At operation 702, the method comprises obtaining by a processor (612) non-Bayer CFA data and non-Bayer CFA pattern type. In an embodiment herein, the processor (612) obtains a non-Bayer raw CFA image data and CFA pattern type from the image sensor (610). In an embodiment herein, the non-Bayer raw CFA image data includes a plurality of repeating patterns of a fixed block having multiple RGB color pixels, and a plurality of pre-defined number of sub-blocks present within the fixed block, wherein each sub-block of the plurality of sub-blocks has uniform color pixels. In an embodiment herein, the fixed block is a recurrent pixel block following a common pixel pattern at block level and uniform color pattern at sub-block level. In an embodiment herein, the processor (612) can generate a non-Bayer feature map from the non-Bayer raw CFA image data.

At operation 704, the method comprises, creating by the processor (612) a position dependent directional interpolation layer. In an embodiment herein, the processor (612) creates a position dependent directional interpolation layer for estimating, a plurality of missing colors for each pixel in the non-Bayer feature map, using a position dependent directional interpolation technique for each pixel in the non-Bayer feature map. Further, the processor (612) generates a position dependent directional interpolation feature map from the position dependent directional interpolation technique. In an embodiment herein, estimating the plurality of missing colors include, identifying a plurality of uniform color pixels of at least, a sub-block present within a fixed block of the non-Bayer feature map. Further, estimating the plurality of missing colors include interpolating, for each pixel in the identified sub-block, a plurality of missing RGB color pixels, in a plurality of neighboring sub-blocks associated with a plurality of neighboring fixed blocks of the feature map, using the position dependent directional interpolation for each pixel. Estimating the plurality of missing colors further include, determining, with respect to each pixel of the identified sub-block, a direction of interpolation, corresponding to the plurality of neighboring sub-blocks. Further, estimating the plurality of missing colors include determining, with respect to each pixel of the identified sub-block, a total number of the plurality of neighboring sub-blocks. Estimating the plurality of missing colors further include, determining a plurality of weights for assigning to each pixel in the plurality of neighboring sub-blocks. In an embodiment herein, the direction of interpolation, the total number of the plurality of neighboring sub-blocks and the assigned plurality of weights to each pixel in the plurality of neighboring sub-blocks are determined based on a relative position of each pixel in the identified sub-block and a plurality of RGB color pixels, in the plurality of neighboring sub-blocks, and a color of each pixel in the identified sub-block and a color of each pixel, in the plurality of neighboring sub-blocks.

At operation 706, the method comprises, creating by the processor (612) a position aware gradient computation layer. In an embodiment herein, the processor (612) creates a position aware gradient computation layer for estimating the rate of change of color for each pixel in the non-Bayer feature map, using a position aware gradient technique for each pixel in the non-Bayer feature map. Further, the processor (612) generates a position aware gradient feature map using the position dependent directional interpolation technique. In an embodiment herein, estimating the rate of change of color for each pixel in the non-Bayer feature map includes, identifying a plurality of uniform color pixels of at least, a sub-block present within a fixed bock of the feature map. Further, estimating rate of change of color for each pixel in the non-Bayer feature map includes estimating the rate of change of color, for each pixel in the identified sub-block, with respect to a plurality of RGB color pixels in a plurality of neighboring sub-blocks associated with a plurality of neighboring fixed blocks of the feature map, using the position aware gradient for each pixel. Estimating rate of change of color for each pixel in the non-Bayer feature map further includes, determining, with respect to each pixel of the identified sub-block, a direction of estimation for the rate of change of color, with respect to the plurality of neighboring sub-blocks. Further, estimating the rate of change of color for each pixel in the non-Bayer feature map includes, determining, with respect to each pixel of the identified sub-block, a total number of the plurality of neighboring sub-blocks. Estimating the rate of change of color for each pixel in the non-Bayer feature map further includes, determining the plurality of weights for assigning to each pixel in the plurality of neighboring sub-blocks. In an embodiment herein, the direction of estimation, the total number of the plurality of neighboring sub-blocks and the assigned plurality of weights to each pixels in the plurality of neighboring sub-blocks are determined based on a relative position of each pixel in the identified sub-block and a plurality of RGB color pixels, in the plurality of neighboring sub-blocks, and a color of each pixel in the identified sub-block and a color of each pixel, in the plurality of neighboring sub-blocks.

At operation 708, the method comprises, combining by the processor (612), the directional interpolation layer and the gradient computation layer. In an embodiment herein, the processor (612) generates a combined gradient aware position interpolation feature map from the position dependent interpolation feature map and the position aware gradient feature map, as obtained from the position dependent directional interpolation technique and the position aware gradient technique respectively, in order to obtain a derived color image.

At operation 710, the method comprises, generating by the processor 612), a demosaic AI model using the non-Bayer CFA data and the CFA pattern type. In an embodiment herein, the processor (612) generates the light weight demosaic AI model from the non-Bayer raw CFA image data and the CFA pattern type. In an embodiment here, the demosaic AI model can be at least a DNN model.

At operation 712, the method comprises, performing fusion of the directional interpolation layer, the gradient computation layer and the demosaic AI model. In an embodiment herein, the processor (612) fuses the directional interpolation layer, the gradient computation layer and the DNN model for demosaicing the raw non-Bayer CFA pattern and obtaining a full RGB color image.

The various actions in method 700 may be performed in the order presented, in a different order or simultaneously. Further, in some embodiments, some actions listed in FIG. 7 may be omitted.

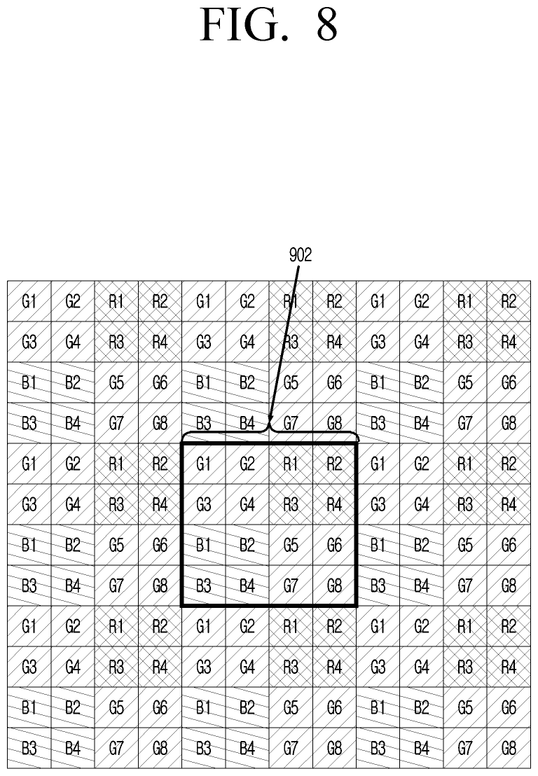

FIG. 8 depicts an example demosaic architecture generation-directional interpolation schematic, according to an embodiment of the disclosure.

The directional interpolation module can use a schematic to generate a position dependent directional interpolated feature map. In an embodiment herein, interpolation direction is deployed, based on position of a pixel in a fixed pattern (902), at a plurality of sub blocks within the fixed pattern (902), and each neighborhood pixel in the plurality of sub blocks. For each pixel in the fixed pattern, 2 missing colors are interpolated. As depicted in the example in FIG. 8, for a red pixel, blue, and green are interpolated; for a green pixel, red and blue are interpolated; and for a blue pixel, red and green are interpolated.

The highlighted box (902) is the fixed pattern received by the processor (612) from the image sensor (610), which is repeated in raw data. For example, in tetra raw data, the size of the fixed pattern is 4*4 where each sub block size is 2*2. There are 4 sub blocks:
1—(G1, G2, G3, G4): Interpolate red and blue.
2—(R1, R2, R3, R4): Interpolate green and blue.
3—(B1, B2, B3, B4): Interpolate red and green.
4—(G5, G6, G7, G8): Interpolate red and blue.

Interpolation direction, neighbors and weights can be computed based on position in fixed pattern and sub block. For example, even though sub block1 and sub block4 are green in color, the method of interpolating red and blue can differ for both the blocks. In an embodiment herein, the fixed pattern is a recurrent pixel block following a common pixel pattern at block level and uniform color pattern at sub-block level.

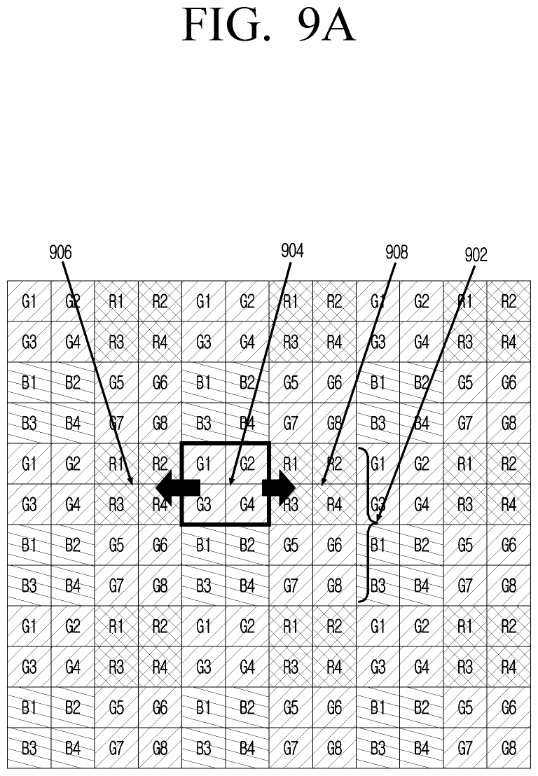

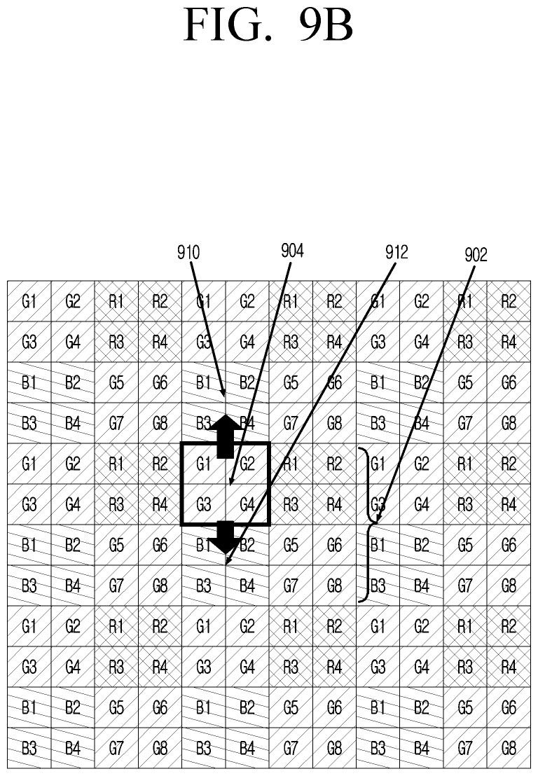

FIG. 9A depicts an example method for interpolating red using a horizontal direction for a sub block, according to an embodiment of the disclosure.

Direction interpolation schematic for sub block1 (G1, G2, G3, G4) (904) of a recurrent pixel block (902), for red color is estimated. In an embodiment herein, the directional interpolation for red color at sub block1 (904) is performed horizontally. Further, a weighted combination of each pixel in the left neighboring sub block (906) and the right neighboring sub block (908) is used. At sub block1 (904), the red value at G1 can be computed as (w1*R1+w2*R2+w3*R3+w4*R4)+(w5*R1+w6*R2+w7*R3+w8*R4), where w1, w2, w3, w4, w5, w6, w7, w8 are a plurality of weights assigned for each pixel in the left neighboring sub block (906) and the right neighboring sub block (908). In an embodiment herein, the plurality of weights are computed based on distance of G1 with pixels in the left and right sub blocks. Further, the red value at G2 is computed as (w9*R1+w10*R2+w11*R3+w12*R4)+(w13*R1+w14*R2+w15*R3+w16*R4), where w9, w10, w11, w12, w13, w14, w15, and w16 are a plurality of weights assigned for each pixel in the left neighboring sub block (906) and the right neighboring sub block (908). In an embodiment herein, the plurality of weights are computed based on distance of G2 with pixels in the left sub block (906) and right sub block (908). At sub block1 (904), the red value at G3 is computed as (w17*R1+w18*R2+w19*R3+w20*R4)+(w21*R1+w22*R2+w23*R3+w24*R4), where w17, w18, w19, w20, w21, w22, w23, and w24 are a plurality of weights assigned for each pixel in the left neighboring sub block (906) and the right neighboring sub block (908). In an embodiment herein, the plurality of weights are computed based on distance of G3 with pixels in the left sub block (906) and right sub block (908). At sub block1 (904), the red value at G4 is computed as (w25*R1+w26*R2+w27*R3+w28*R4)+(w29*R1+w30*R2+w31*R3+w32*R4). In an embodiment herein, w25, w26, w27, w28, w29, w30, w31, and w32 are a plurality of weights assigned for each pixel in the left neighboring sub block (906) and the right neighboring sub block (908). The plurality of weights can be computed based on distance of G4 with pixels in the left sub block (906) and the right sub block (908).

FIG. 9B depicts an example method for interpolating blue using a vertical direction for a sub block, according to an embodiment of the disclosure.

A direction interpolation schematic for sub block1 (G1, G2, G3, G4) (904) of the recurrent pixel block (902), for blue is estimated, wherein the blue color is interpolated at sub block1 (904) in a vertical direction. The weighted combination of the upper neighboring sub block (910) and the down neighboring sub block (912) can be used. The blue value at G1 is computed as (w1*B1+w2*B2+w3*B3+w4*B4)+(w5*B1+w6*B2+w7*B3+w8*B4), where w1, w2, w3, w4, w5, w6, w7, and w8 are a plurality of weights assigned for each pixel in the upper neighboring sub block (910) and down neighboring sub block (912). The plurality of weights can be computed based on distance of G1 with pixels in up and down sub blocks. At sub block1 (904), blue value at G2 is computed as (w9*B1+w10*B2+w11*B3+w12*B4)+(w13*B1+w14*B2+w15*B3+w16*B4), where w9, w10, w11, w12, w13, w14, w15, and w16 are a plurality of weights assigned for each pixel in the upper neighboring sub block (910) and the down neighboring sub block (912). The plurality of weights are computed based on the distance of G2 with pixels in the up and down sub blocks. Blue value at G3 is computed as (w17*B1+w18*B2+w19*B3+w20*B4)+(w21*B1+w22*B2+w23*B3+w24*B4), where w17, w18, w19, w20, w21, w22, w23, and w24 are a plurality of weights assigned for each pixel in the upper neighboring sub block (910) and the down neighboring sub block (912). The plurality of weights are computed based on distance of G3 with pixels in the up and down sub blocks. At sub block1 (904), the blue value at G4 is computed as (w25*B1+w26*B2+w27*B3+w28*B4)+(w29*B1+w30*B2+w31*B3+w32*B4) where w25, w26, w27, w28, w29, w30, w31, and w32 are a plurality of weights assigned for each pixel in the upper neighboring sub block (910) and the down neighboring sub block (912). The plurality of weights are computed based on distance of G4 with pixels in the upper neighboring sub block (910) and the down neighboring sub block (912).

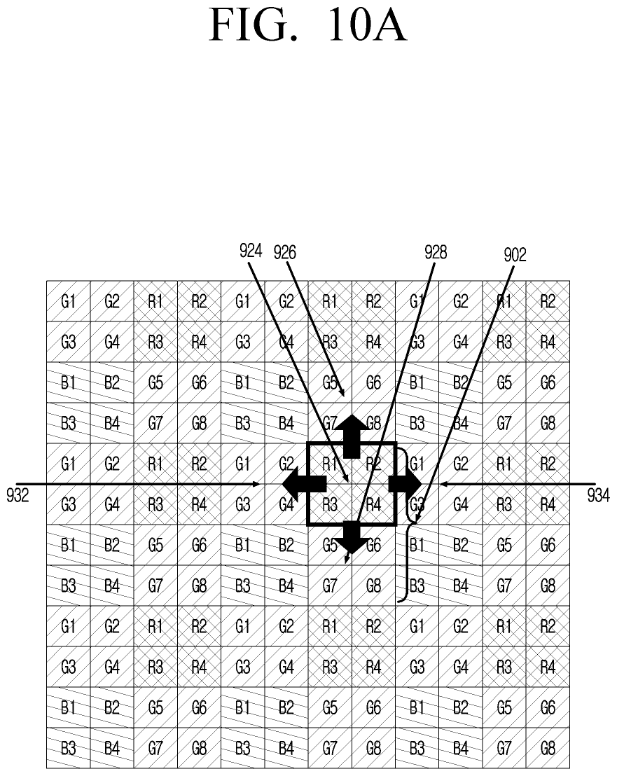

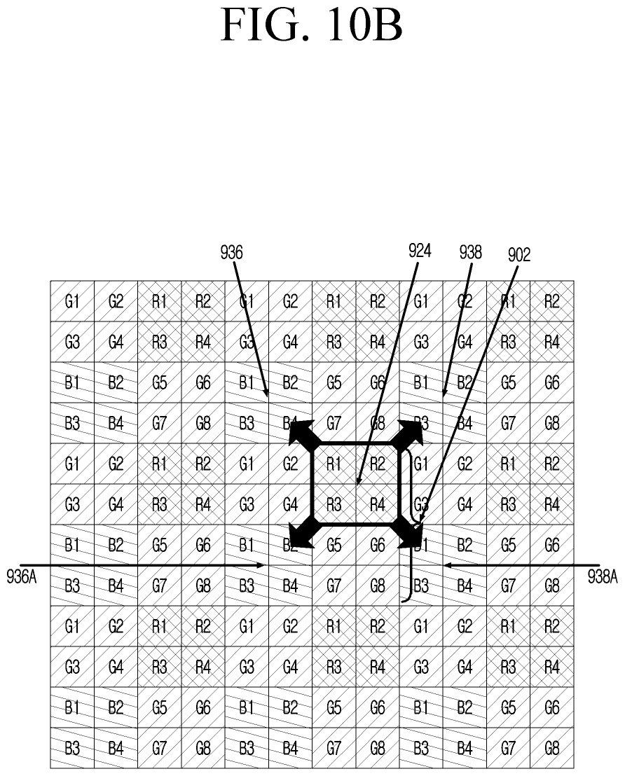

FIG. 10A depicts an example method for interpolating green using horizontal and vertical directions for a sub block, according to an embodiment of the disclosure.

Direction interpolation schematic for sub block2 (R1, R2, R3, R4) (924) of the recurrent pixel block (902) is estimated in the vertical and horizontal directions. The weighted combination of the upper sub block (926), the down sub block (928), the left sub block (932), and the right sub block (934) are determined. At sub block2 (924), green value of R1 is computed as w1*[G1, G2, G3, G4]+w2*[G5, G6, G7, G8]+w3*[G1, G2, G3, G4]+w4*[G5, G6, G7, G8], where w1, w2, w3, and w4 are vectors of size 4 and weights for each vector (w1, w2, w3, w4) are computed using distance of R1 with pixels in the left (932), right (934), upper (926), and down (928) neighboring sub blocks of the sub block2 (924). At sub block2 (924), green value of R2 is computed as w5*[G1, G2, G3, G4]+w6*[G5, G6, G7, G8]+w7*[G1, G2, G3, G4]+w8*[G5, G6, G7, G8], where w5, w6, w7, and w8 are vectors of size 4. In an embodiment herein, weights in each vector (w5, w6, w7, and w8) are computed using distance of R2 with pixels to the left (932), right (934), upper (926), and down (928) neighboring sub blocks of the sub block (924). At sub block2 (924), Green value of R3 is computed as w9*[G1, G2, G3, G4]+w10*[G5, G6, G7, G8]+w11*[G1, G2, G3, G4]+w12*[G5, G6, G7, G8], where w9, w10, w11, and w12 are vectors of size 4. In an embodiment herein, weights in each vector (w9, w10, w11, and w12) are computed using distance of R3 with pixels in the left (932), right (934), upper (926), and down (928) neighboring sub blocks of the sub block2 (924). At sub block2 (924), the green value of R4 is computed as w13*[G1, G2, G3, G4]+w14*[G5, G6, G7, G8]+w15*[G1, G2, G3, G4]+w16*[G5, G6, G7, G8], where w13, w14, w15, and w16 are vectors of size 4. In an embodiment herein, weights in each vector (w13, w14, w15, and w16) are computed using distance of R4 with pixels in the left (932), right (934), upper (926), and down (928) neighboring sub blocks of the sub block2.

FIG. 10B depicts an example method for interpolating blue interpolation using a diagonal direction for a sub block, according to an embodiment of the disclosure.

Direction interpolation schematic for sub block2 (R1, R2, R3, R4) (924) of the recurrent pixel block (902), is estimated in the diagonal direction. The weighted combination of the left up diagonal neighboring sub block (936), the left down diagonal neighboring sub block (936A), the right up diagonal neighboring sub block (938), and the right down diagonal neighboring sub block (938A), are determined by the processor (612). At sub block2 (924), the blue value of R1 is computed as w1*[B1, B2, B3, B4]+w2*[B1, B2, B3, B4]+w3*[B1 B2, B3, B4]+w4*[B1, B2, B3, B4], where w1, w2, w3 and w4 are vectors of size 4. In an embodiment herein, the weights in each vector are computed using distance of R1 from each pixels in the left up diagonal neighboring sub block (936), the left down diagonal neighboring sub block (936A), the right up diagonal neighboring sub block (938), and the right down diagonal neighboring sub block (938A). At sub block2 (924), the blue value of R2 is computed as w5*[B1, B2, B3, B4]+w6*[B1, B2, B3, B4]+w7*[B1, B2, B3, B4]+w8*[B1, B2, B3, B4], where w5, w6, w7 and w8 are vectors of size 4. In an embodiment herein, the weights in each vector of w5, w6, w7 and w8, are computed using the distance of R2 from each pixels in the left up diagonal neighboring sub block (936), the left down diagonal neighboring sub block (936A), the right up diagonal neighboring sub block (938), and the right down diagonal neighboring sub block (938A). At sub block2 (924), the blue value of R3 is computed as w9*[B1, B2, B3, B4]+w10*[B1, B2, B3, B4]+w11*[B1, B2, B3, B4]+w12*[B1, B2, B3, B4], where w9, w10, w11, and w12 are vectors of size 4. In an embodiment herein, weights in each vector of w9, w10, w11, and w12 is computed using distance of R3 from each pixel in the left up diagonal neighboring sub block (936), the left down diagonal neighboring sub block (936A), the right up diagonal neighboring sub block (938), and the right down diagonal neighboring sub block (938A). At sub block2 (924), the blue value of R4 is computed as w13*[B1, B2, B3, B4]+w14*[B1, B2, B3, B4]+w15*[B1, B2, B3, B4]+w16*[B1, B2, B3, B4], where w13, w14, w15, and w16 are vectors of size 4. In an embodiment herein, weights in each vector of w13, w14, w15, and w16 are computed using distance of R4 from each pixel in the left up diagonal neighboring sub block (936), the left down diagonal neighboring sub block (936A), the right up diagonal neighboring sub block (938), and the right down diagonal neighboring sub block (938A).

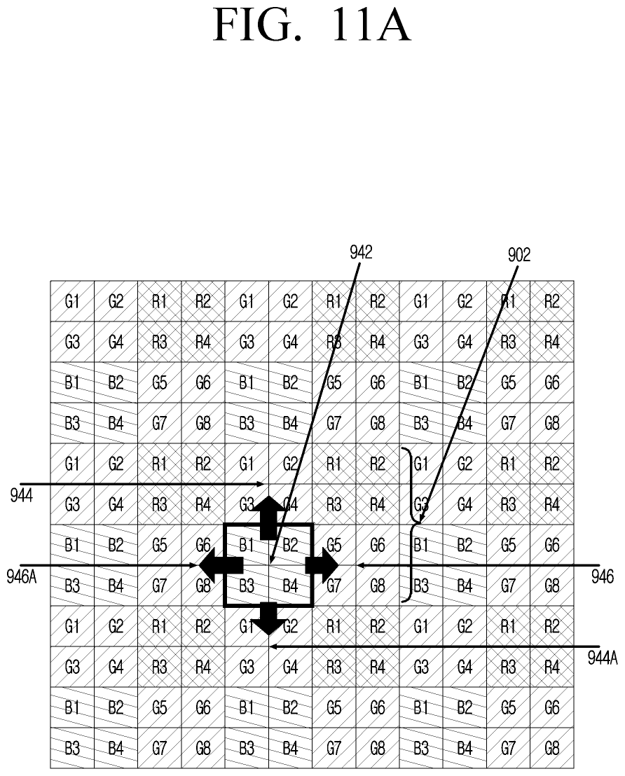

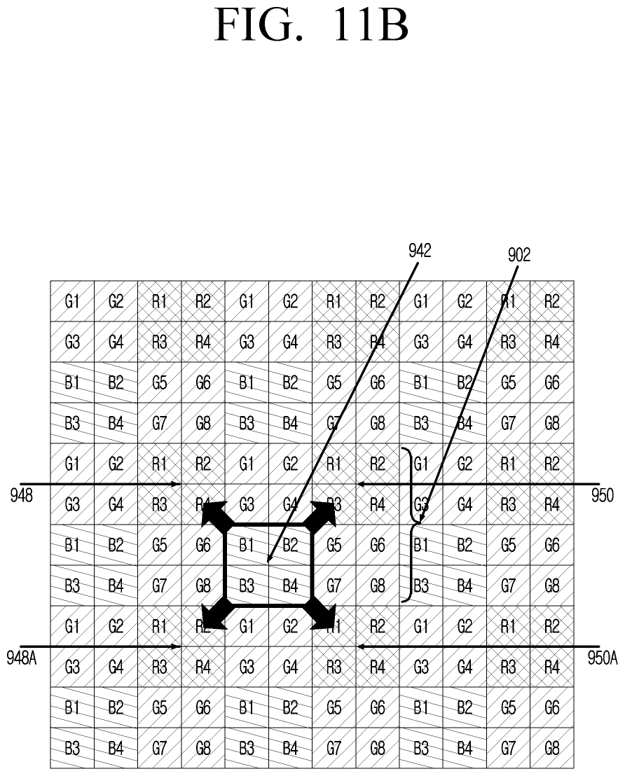

FIG. 11A depicts an example method for interpolating green interpolation using vertical and horizontal directions for a sub block, according to an embodiment of the disclosure.

As depicted interpolating green using vertical and horizontal direction for sub block3 (942) of the recurrent pixel block (902). The direction interpolation schematic for sub block3 (B1, B2, B3, B4) (942) is estimated in the vertical and horizontal directions. The weighted combination of the left neighboring sub block (944), the up neighboring sub block (946), the right neighboring sub block (944A), and the down neighboring sub block (946A) are estimated by the directional interpolation estimation engine (622) of the processor (612). At sub block3 (942), the green value of B1 is computed as w1*[G5, G6, G7, G8]+w2*[G1, G2, G3, G4]+w3*[G5, G6, G7, G8]+w4*[G1, G2, G3, G4], where w1, w2, w3, and w4 are vector of size 4. In an embodiment herein, weights in each vector of w1, w2, w3, and w4 are computed using the distance of B1 with pixels in the left (944), the right (944A), the up (946), and the down (946A) neighboring sub blocks. At sub block3 (942), the green value of B2 is computed as w5*[G5, G6, G7, G8]+w6*[G1, G2, G3, G4]+w7*[G5, G6, G7, G8]+w8*[G1, G2, G3, G4], where w5, w6, w7, and w8 are vectors of size 4. In an embodiment herein, the weight in each vector of w5, w6, w7, and w8 is computed using distance of B2 with pixels the left (944), the right (944A), the up (946), and the down (946A) neighboring sub blocks. At sub block3 (942), the green value of B3 is computed as w9*[G5, G6, G7, G8]+w10*[G1, G2, G3, G4]+w11*[G5, G6, G7, G8]+w12*[G1, G2, G3, G4], where w9, w10, w11, and w12 are vectors of size 4. In an embodiment herein, the weights in each vector of w9, w10, w11, and w12, is computed using distance of B3 with pixels in the left (944), the right (944A), the up (946), and the down (946A) neighboring sub blocks. At sub block3 (942), the green value of B4 is computed as w13*[G5, G6, G7, G8]+w14*[G1, G2, G3, G4]+w15*[G5, G6, G7, G8]+w16*[G1, G2, G3, G4], where w13, w14, w15, and w16 is a vector of size 4. In an embodiment herein, the weights in each vector of w13, w14, w15, and w16, is computed using distance of B4 with pixels in the left (944), the right (944A), the up (946), and the down (946A) neighboring sub blocks.

FIG. 11B depicts an example method for interpolating red using a diagonal direction for a sub block, according to an embodiment of the disclosure.

As depicted, position dependent interpolation of red in a diagonal direction for sub block3 (942). The direction interpolation schematic for sub block3 (B1, B2, B3, B4) (942) of the recurrent pixel block (902) is estimated diagonally. The weighted combination of the left up neighboring sub block (948), the left down neighboring sub block (948A), the right up neighboring sub block (950), and the right down neighboring sub block (950A). At sub block3 (942), the red value of B1 is computed as w1*[R1, R2, R3, R4]+w2*[R1, R2, R3, R4]+w3*[R1, R2, R3, R4]+w4*[R1, R2, R3, R4], where w1, w2, w3, and w4 are vectors of size 4. In an embodiment herein, weight in each vector of w1, w2, w3, and w4, is computed using distance of B1 with pixels in the left up neighboring sub block (948), the left down neighboring sub block (948A), the right up neighboring sub block (950), and the right down neighboring sub block (950A). At sub block3 (942), the red value of B2 is computed as w5*[R1, R2, R3, R4]+w6*[R1, R2, R3, R4]+w7*[R1, R2, R3, R4]+w8*[R1, R2, R3, R4], where w5, w6, w7, and w8 are vectors of size 4. In an embodiment herein, the weight in each vector of w5, w6, w7, and w8 is computed using distance of B2 with pixels in the left up neighboring sub block (948), the left down neighboring sub block (948A), the right up neighboring sub block (950), and the right down neighboring sub block (950A). At sub block3 (942), the red value of B3 is computed as w9*[R1, R2, R3, R4]+w10*[R1, R2, R3, R4]+w11*[R1, R2, R3, R4]+w12*[R1, R2, R3, R4], where w9, w10, w11, and w12 are vectors of size 4. In an embodiment herein, the weight in each vector of w9, w10, w11, and w12 is computed using distance of B3 with pixels in the left up neighboring sub block (948), the left down neighboring sub block (948A), the right up neighboring sub block (950), and the right down neighboring sub block (950A). At sub block3 (942), the red value of B4 is computed as w13*[R1, R2, R3, R4]+w14*[R1, R2, R3, R4]+w15*[R1, R2, R3, R4]+w16*[R1, R2, R3, R4], where w13, w14, w15, and w16 are vectors of size 4. In an embodiment herein, the weight in each vector of w13, w14, w15, and w16 is computed using distance of B4 with pixels in the left up neighboring sub block (948), the left down neighboring sub block (948A), the right up neighboring sub block (950), and the right down neighboring sub block (950A).

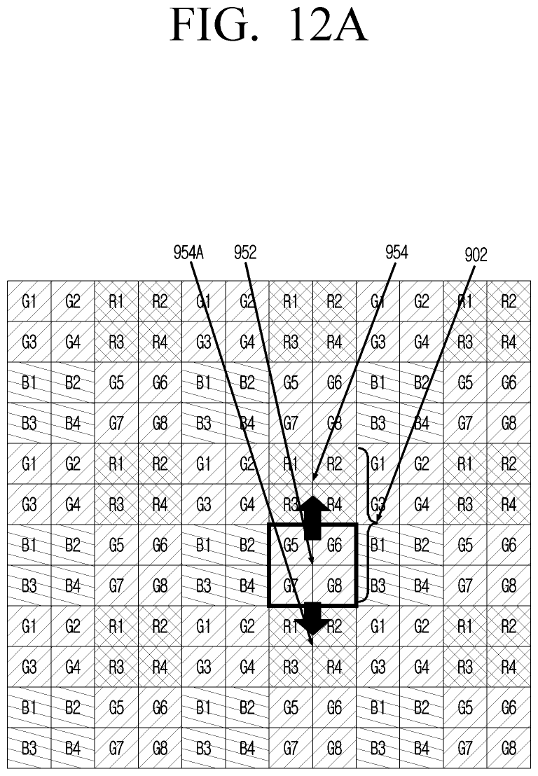

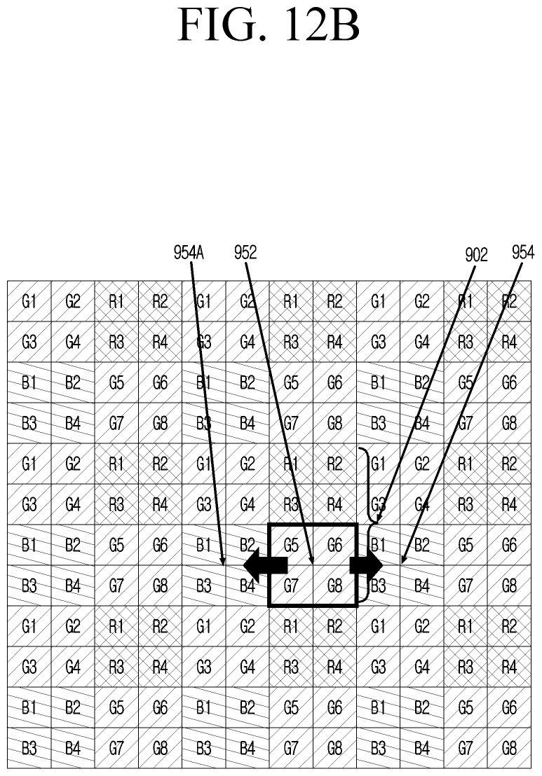

FIG. 12A depicts an example method for interpolating red using a vertical direction, according to an embodiment of the disclosure.

The direction interpolation schematic for Sub block4 (G5, G6, G7, G8) (952) is estimated by the processor (612) in a vertical direction from the sub block4 (G5, G6, G7, G8) (952). The weighted combination of the up neighboring sub block (954), and the down neighboring sub block (954A) are determined. At sub block4 (952), the red value of G5 is computed as w1*[R1, R2, R3, R4]+w2*[R1, R2, R3, R4], where w1 and w2 are vectors of size 4. In an embodiment herein, the weight in each vector of w1 and w2 is computed using distance of G5 with pixels in the up neighboring sub block (954), and the down neighboring sub block (954A). At sub block4 (952), the red value of G6 is computed as w3*[R1, R2, R3, R4]+w4*[R1, R2, R3, R4] where w3 and w4 are vectors of size. In an embodiment herein, the weights in each vector of w3 and w4 is computed using distance of G6 with pixels in the up neighboring sub block (954), and the down neighboring sub block (954A). At sub block4 (952), the red value of G7 is computed as w5*[R1, R2, R3, R4]+w6*[R1, R2, R3, R4], where w5 and w6 are vectors of size 4. In an embodiment herein, the weights in each vector of w7 and w8 is computed using distance of G7 with pixels in the up neighboring sub block (954), and the down neighboring sub block (954A). At sub block4 (952), the red value of G8 is computed as w7*[R1, R2, R3, R4]+w8*[R1, R2, R3, R4], where w7 and w8 are vectors of size 4. In an embodiment herein, the weights in each vector of w7 and w8 are computed using distance of G8 with pixels in the up neighboring sub block (954), and the down neighboring sub block (954A).

FIG. 12B depicts an example method for interpolating blue using a horizontal direction, according to an embodiment of the disclosure.

The direction interpolation schematic for the sub block4 (952) (G5, G6, G7, G8) of the recurrent pixel block (902), is estimated horizontally. The weighted combination of the left neighboring sub block (956), and the right neighboring sub block (956A) is determined. At sub block4 (952), the blue value of G5 is computed as w1*[B1, B2, B3, B4]+w2*[B1, B2, B3, B4] where w1 and w2 are vectors of size 4. In an embodiment herein, the weights in each vector of w1 and w2 are computed using distance of G5 with pixels in the left neighboring sub block (956), and the right neighboring sub block (956A). At sub block4 (952), the blue value of G6 is computed as w3*[B1, B2, B3, B4]+w4*[B1, B2, B3, B4] where w3 and w4 are vectors of size 4. In an embodiment herein, the weights in each vector of w3 and w4 are computed using distance of G6 with pixels in left neighboring sub block (956), and the right neighboring sub block (956A). At sub block4 (952), the blue value of G7 is computed as w5*[B1, B2, B3, B4]+w6*[B1, B2, B3, B4], where w5 and w6 are vectors of size 4. In an embodiment herein, the weights in each vector of w5 and w6, is computed using distance of G7 with pixels in the left neighboring sub block (956), and the right neighboring sub block (956A). At sub block4 (952), the blue value of G8 is computed as w7*[B1, B2, B3, B4]+w*[B1, B2, B3, B4] where w7 and w8 are vectors of size 4. In an embodiment herein, the weights in each vector of w7 and w8 is computed using distance of G8 with pixels in left neighboring sub block (956), and the right neighboring sub block (956A).

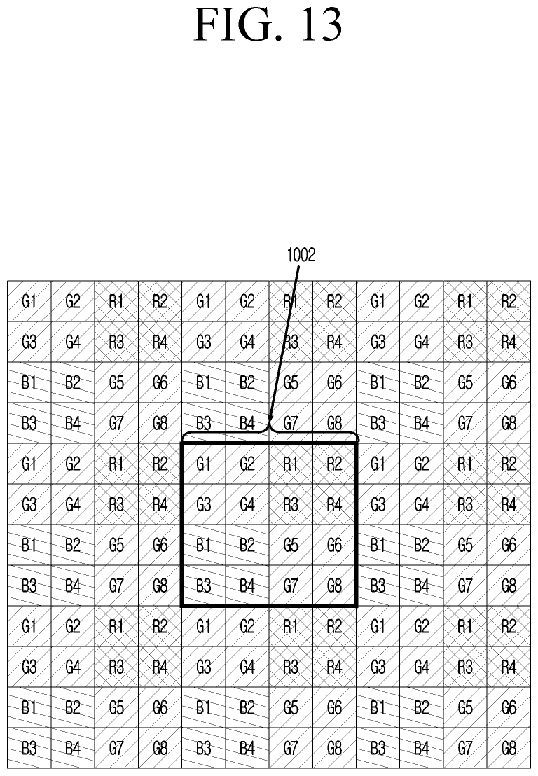

FIG. 13 depicts an example demosaic architecture generation-gradient computation schematic, according to an embodiment of the disclosure.

The position aware gradient block uses a schematic to generate the position dependent gradient feature map. Based on the position of a pixel in a fixed pattern (1002), sub block neighborhood pixels and color of pixel, the gradient feature is computed. Based on the color and position of a pixel, the window of gradient computation for that pixel changes. For each pixel, only 1 gradient is computed. For a red pixel, a red gradient is computed. For a green pixel, a green gradient is computed. For a blue pixel, a blue gradient is computed. As depicted in FIG. 13, the highlighted box (1002) (recurrent pixel block) is the fixed pattern in sensor capture which is repeated in raw data. For example, in a tetra raw data size of fixed pattern is 4*4, where each sub block size is 2*2. There are 4 sub blocks:
1—(G1, G2, G3, G4): Compute the green gradient.
2—(R1, R2, R3, R4): Compute the red gradient.
3—(B1, B2, B3, B4): Compute the blue gradient.
4—(G5, G6, G7, G8): Compute the green gradient.

The gradient computation window and weights are computed based on color, and position of a pixel in fixed pattern and sub block.

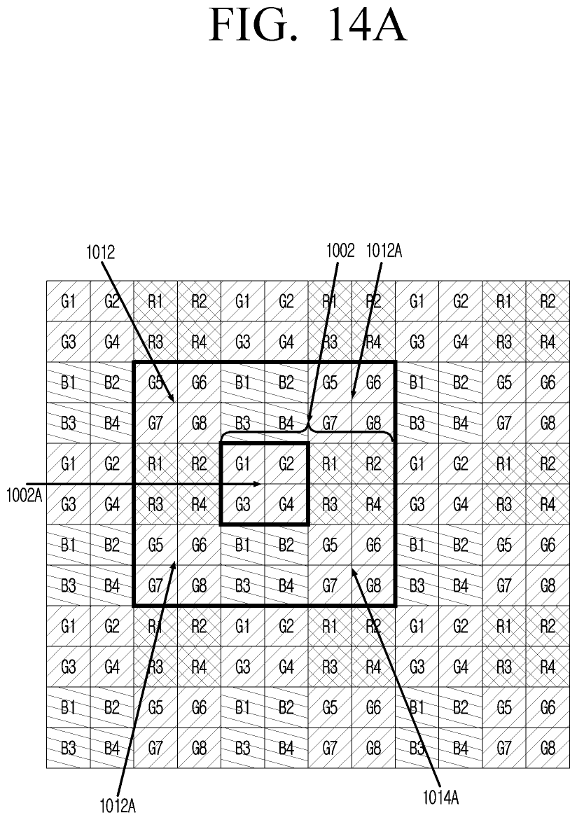

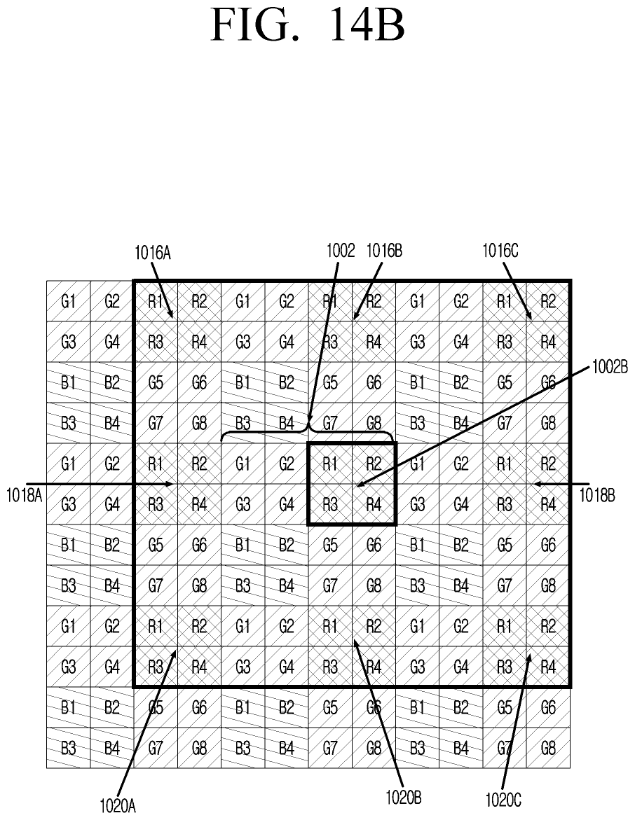

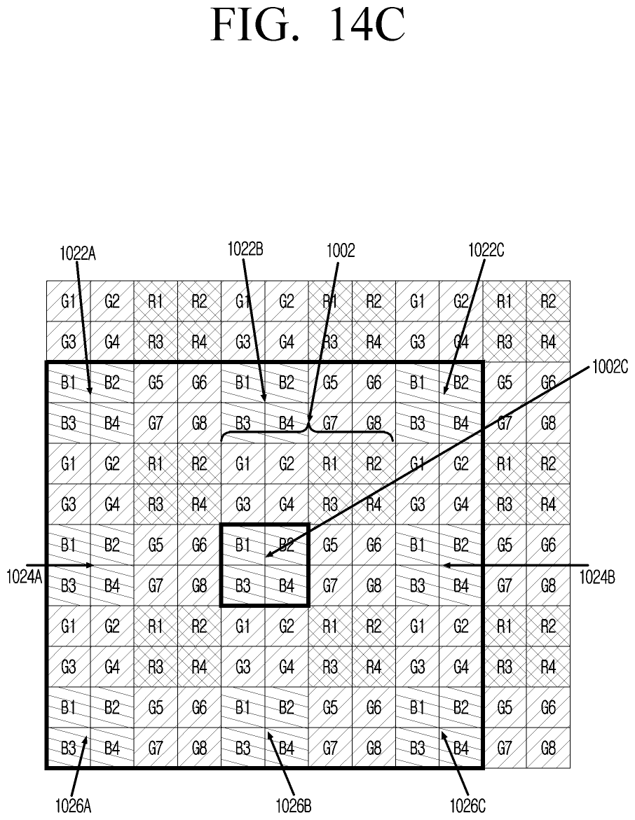

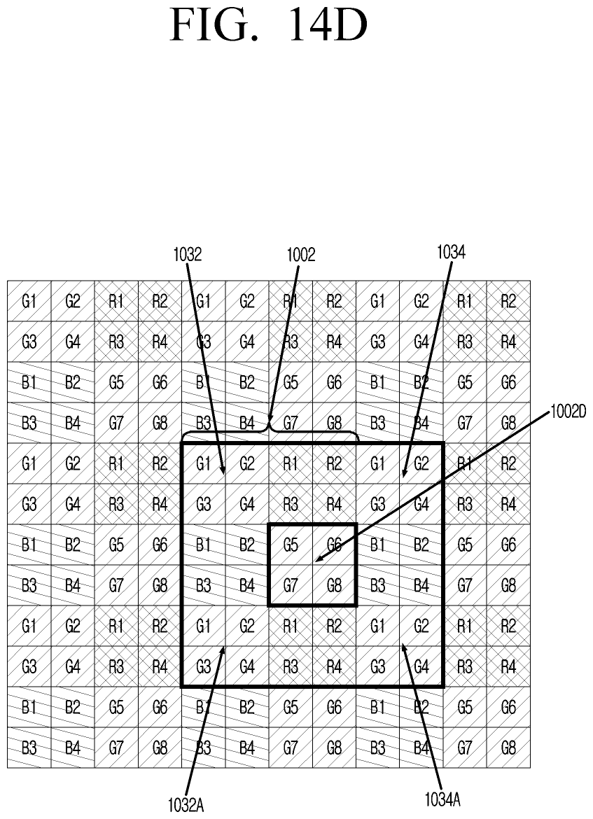

FIG. 14A depicts an example method for computing a Green gradient using 6*6 neighborhood window, according to an embodiment of the disclosure.

Gradient computation interpolation schematic for Sub block1 (G1, G2, G3, G4) (1002A) of the recurrent pixel block (1002). The green gradient computation is performed using green sub blocks in 6*6 windows. the weighted combination of the left up neighboring sub block (1012), the left down neighboring sub block (1012A), the right up neighboring sub block (1014), and the right down neighboring sub block (1014A). At sub block1 (1002A), the green gradient at G1 is computed as w1*[G5, G6, G7, G8]+w2*[G5, G6, G7, G8]+w3*[G5, G6, G7, G8]+w4*[G5, G6, G7, G8], where w1, w2, w3, and w4 are vectors of size 4. In an embodiment herein, the weights in each vector of w1, w2, w3, and w4 are computed using distance of G1 with pixels in the left up neighboring sub block (1012), the left down neighboring sub block (1012A), the right up neighboring sub block (1014), and the right down neighboring sub block (1014A). At sub block1 (1002A), the green gradient at G2 is computed as w5*[G5, G6, G7, G8]+w6*[G5, G6, G7, G8]+w7*[G5, G6, G7, G8]+w8*[G5, G6, G7, G8], where w5, w6, w7, and w8 are vectors of size 4. In an embodiment herein, the weights in each vector of w5, w6, w7, and w8 are computed using distance of G2 with pixels in the left up neighboring sub block (1012), the left down neighboring sub block (1012A), the right up neighboring sub block (1014), and the right down neighboring sub block (1014A). At sub block1 (1002A), the green gradient at G3 is computed as w9*[G5, G6, G7, G8]+w10*[G5, G6, G7, G8]+w11*[G5, G6, G7, G8]+w12*[G5, G6, G7, G8], where w9, w10, w11, and w12 are vectors of size 4. In an embodiment herein, the weights in each vector of w9, w10, w11, and w12 are computed using distance of G3 with pixels in the left up neighboring sub block (1012), the left down neighboring sub block (1012A), the right up neighboring sub block (1014), and the right down neighboring sub block (1014A). At sub block1 (1002A), the green gradient at G4 is computed as w13*[G5, G6, G7, G8]+w14*[G5, G6, G7, G8]+w15*[G5, G6, G7, G8]+w16*[G5, G6, G7, G8], where w13, w14, w15, and w16 are vector of size. In an embodiment herein, the weights in each vector of w13, w14, w15, and w16 are computed using distance of G4 with pixels in the left up neighboring sub block (1012), the left down neighboring sub block (1012A), the right up neighboring sub block (1014), and the right down neighboring sub block (1014A).

FIG. 14B depicts an example method for computing a Red gradient using a 10*10 neighborhood window, according to an embodiment of the disclosure. The gradient computation interpolation schematic for a sub block2 (R1, R2, R3, R4) (1002B) is estimated using the red sub blocks in 10*10 windows. The weighted combination of three up neighboring sub blocks (1016A, 1016B, 1016C), two horizontal neighboring sub blocks (1018A, 1018B), and three down sub neighboring blocks (1020A, 1020B, 1020C). At sub block2 (1002B), the red gradient at R1 is computed using w1*[R1, R2, R3, R4]+w2*[R1, R2, R3, R4]+w3*[R1, R2, R3, R4]+w4*[R1, R2, R3, R4]+w5*[R1, R2, R3, R4]+w6*[R1, R2, R3, R4]+w7*[R1, R2, R3, R4]+w8*[R1, R2, R3, R4]. In an embodiment herein, the weights w1, w2, w3, w4, w5, w6, w7, and w8 are computed using distance of R1 with the three up neighboring sub blocks (1016A, 1016B, 1016C), the two horizontal neighboring sub blocks (1018A, 1018B), and the three down sub neighboring blocks (1020A, 1020B, 1020C). At sub block2 (1002B), the red gradient at R2 is computed using w9*[R1, R2, R3, R4]+w10*[R1, R2, R3, R4]+w11*[R1, R2, R3, R4]+w12*[R1, R2, R3, R4]+w13*[R1, R2, R3, R4]+w14*[R1, R2, R3, R4]+w15*[R1, R2, R3, R4]+w16*[R1, R2, R3, R4]. In an embodiment herein, the weights w9, w10, w11, w12, w13, w14, w15, and w16 are computed using distance of R2 with the three up neighboring sub blocks (1016A, 1016B, 1016C), the two horizontal neighboring sub blocks (1018A, 1018B), and the three down sub neighboring blocks (1020A, 1020B, 1020C). At sub block2 (1002B), the red gradient at R3 is computed using w17*[R1, R2, R3, R4]+w18*[R1, R2, R3, R4]+w19*[R1, R2, R3, R4]+w20*[R1, R2, R3, R4]+w21*[R1, R2, R3, R4]+w22*[R1, R2, R3, R4]+w23*[R1, R2, R3, R4]+w24*[R1, R2, R3, R4]. In an embodiment herein, the weights w17, w18, w19, w20, w21, w22, w23, and w24, are computed using distance of R3 with the three up neighboring sub blocks (1016A, 1016B, 1016C), the two horizontal neighboring sub blocks (1018A, 1018B), and the three down sub neighboring blocks (1020A, 1020B, 1020C). At sub block2 (1002B), the red gradient at R4 is computed using w25*[R1, R2, R3, R4]+w26*[R1, R2, R3, R4]+w27*[R1, R2, R3, R4]+w28*[R1, R2, R3, R4]+w29*[R1, R2, R3, R4]+w30*[R1, R2, R3, R4]+w31*[R1, R2, R3, R4]+w32*[R1, R2, R3, R4]. In an embodiment herein, the weights w25, w26, w27, w27, w28, w29, w30, w31, and w32 are computed using distance of R4 with the three up neighboring sub blocks (1016A, 1016B, 1016C), the two horizontal neighboring sub blocks (1018A, 1018B), and the three down sub neighboring blocks (1020A, 1020B, 1020C).

FIG. 14C depicts an example method for computing a Blue gradient using a 10*10 neighborhood window, according to an embodiment of the disclosure. A gradient computation interpolation schematic for sub block three (B1, B2, B3, B4) (1002C) is performed by the processor (612). The blue gradient computation is performed using the blue sub blocks in 10*10 windows. The weighted combination of three up neighboring sub blocks (1022A, 1022B, 1022C), two horizontal neighboring sub blocks (1024A, 1024B), and three down neighboring sub blocks (1026A, 1026B, 1026C). At sub block3 (1002C), the blue gradient at B1 is computed using w1*[B1, B2, B3, B4]+w2*[B1, B2, B3, B4]+w3*[B1, B2, B3, B4]+w4*[B1, B2, B3, B4]+w5*[B1, B2, B3, B4]+w6*[B1, B2, B3, B4]+w7*[B1, B2, B3, B4]+w8*[B1, B2, B3, B4]. In an embodiment herein, the weights w1, w2, w3, w4, w5, w6, w7, and w8 are computed using distance of B1 with the three up neighboring sub blocks (1022A, 1022B, 1022C), the two horizontal neighboring sub blocks (1024A, 1024B), and the three down neighboring sub blocks (1026A, 1026B, 1026C). At sub block3 (1002C), the blue gradient at B2 is computed using w9*[B1, B2, B3, B4]+w10*[B1, B2, B3, B4]+w11*[B1, B2, B3, B4]+w12*[B1, B2, B3, B4]+w13*[B1, B2, B3, B4]+w14*[B1, B2, B3, B4]+w15*[B1, B2, B3, B4]+w16*[B1, B2, B3, B4]. In an embodiment herein, the weights w9, w10, w12, w13, w14, w15, and w16, are computed using distance of B2 with above mentioned neighboring sub blocks. At sub block3 (1002C), the blue gradient at B3 is computed using w17*[B1, B2, B3, B4]+w18*[B1, B2, B3, B4]+w19*[B1, B2, B3, B4]+w20*[B1, B2, B3, B4]+w21*[B1, B2, B3, B4]+w22*[B1, B2, B3, B4]+w23*[B1, B2, B3, B4]+w24*[B1, B2, B3, B4]. In an embodiment herein, the weights w17, w18, w19, w20, w21, w22, w23, and w24 are computed using distance of B3 with the three up neighboring sub blocks (1022A, 1022B, 1022C), the two horizontal neighboring sub blocks (1024A, 1024B), and the three down neighboring sub blocks (1026A, 1026B, 1026C). At sub block3 (1002C), the blue gradient at B4 is computed using w25*[B1, B2, B3, B4]+w26*[B1, B2, B3, B4]+w27*[B1, B2, B3, B4]+w28*[B1, B2, B3, B4]+w29*[B1, B2, B3, B4]+w30*[B1, B2, B3, B4]+w31*[B1, B2, B3, B4]+w32*[B1, B2, B3, B4]. In an embodiment herein, the weights w25, w26, w27, w27, w28, w29, w30, w31 and w32, are computed using distance of B4 with the three up neighboring sub blocks (1022A, 1022B, 1022C), the two horizontal neighboring sub blocks (1024A, 1024B), and the three down neighboring sub blocks (1026A, 1026B, 1026C).

FIG. 14D depicts an example method for computing a Green gradient using a 6*6 neighborhood window for sub block 4, according to an embodiment of the disclosure. A green gradient computation using 6*6 neighborhood window for sub block4 (G5, G6, G7, G8) (1002D) of the recurrent pixel block (1002), is performed by the processor (612). The green gradient computation is performed using green sub blocks in 6*6 windows. The weighted combination of the left up neighboring sub block (1032), the left down neighboring sub block (1032A), the right up neighboring sub block (1034), and the right down neighboring sub block (1034A). At sub block4 (1002D), the green gradient at G5 is computed as w1*[G1, G2, G3, G4]+w2*[G1, G2, G3, G4]+w3*[G1, G2, G3, G4]+w4*[G1, G2, G3, G4] where w1, w2, w3, and w4 are vectors of size 4. In an embodiment herein, the weights in each vector of w1, w2, w3, and w4 are computed using distance of G5 with pixels in the left up neighboring sub block (1032), the left down neighboring sub block (1032A), the right up neighboring sub block (1034), and the right down neighboring sub block (1034A). At sub block4 (1002D), the green gradient at G6 is computed as w5*[G1, G2, G3, G4]+w6*[G1, G2, G3, G4]+w7*[G1, G2, G3, G4]+w8*[G1, G2, G3, G4], where w5, w6, w7, and w8 are vectors of size 4. In an embodiment herein, the weights in each vector of w5, w6, w7, and w8, are computed using distance of G6 with pixels in the left up neighboring sub block (1032), the left down neighboring sub block (1032A), the right up neighboring sub block (1034), and the right down neighboring sub block (1034A). At sub block4 (1002D), the green gradient at G7 is computed as w9*[G1, G2, G3, G4]+w10*[G1, G2, G3, G4]+w11*[G1, G2, G3, G4]+w12*[G1, G2, G3, G4], where w9, w10, w11, and w12 are vectors of size 4. In an embodiment herein, the weights in each vector of w9, w10, w11, and w12 are computed using distance of G7 with pixels the left up neighboring sub block (1032), the left down neighboring sub block (1032A), the right up neighboring sub block (1034), and the right down neighboring sub block (1034A). At sub block4 (1002D), the green gradient at G8 is computed as w13*[G1, G2, G3, G4]+w14*[G1, G2, G3, G4]+w15*[G1, G2, G3, G4]+w16*[G1, G2, G3, G4], where w13, w14, w15, and w16 are vectors of size 4. In an embodiment herein, the weights in each vector of w13, w14, w15, and w16 are computed using distance of G8 with pixels in the left up neighboring sub block (1032), the left down neighboring sub block (1032A), the right up neighboring sub block (1034), and the right down neighboring sub block (1034A).

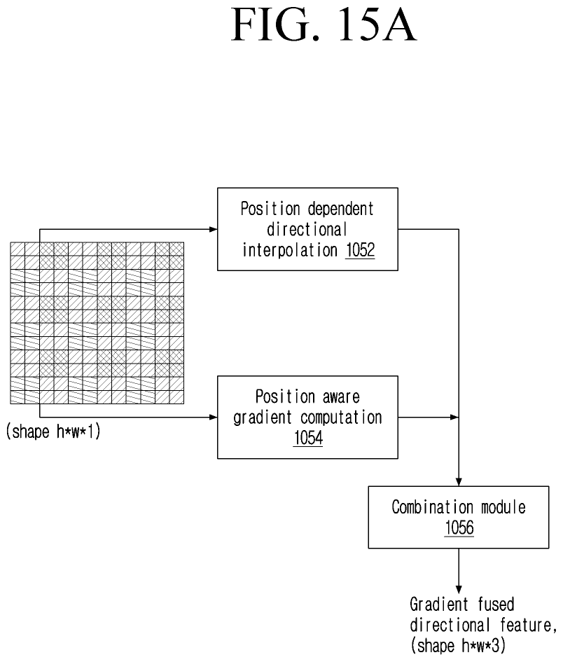

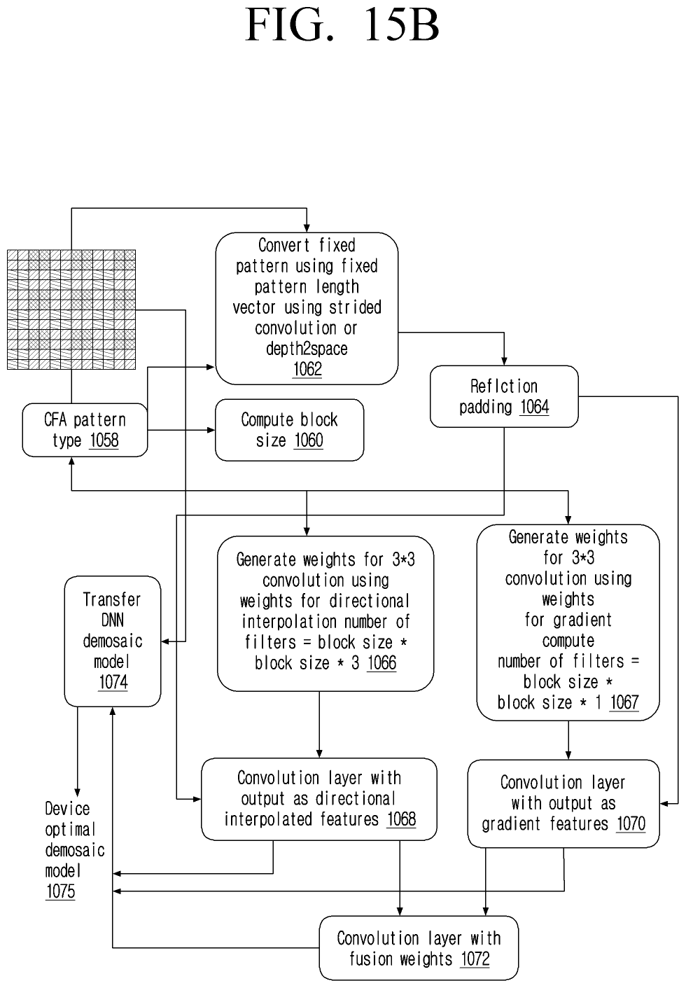

FIG. 15A depicts the example demosaic architecture generation model, according to an embodiment of the disclosure.

A gradient fused direction feature map is created by combining directional interpolated feature obtained from a position dependent directional interpolation (1052), and gradient features obtained from a position aware gradient computation (1054). In an embodiment herein, fusion is performed by the combination module (1056) of the processor (612) using linear, non-linear and scale, and shift operations.

FIG. 15B depicts an example on-device architecture generation algorithm, according to an embodiment of the disclosure.

In an embodiment herein, the processor (612) can convert a non-Bayer feature map to a fixed pattern using a computing method: [(h/block size)*w/(block size)*(block size*block size)], wherein a fixed feature length vector is used for the conversion. The feature length vector can use a strided convolution or depth2space (1062). Here, the processor (612) may use CFA patter type (1058), compute block size (1060), and reflection padding (1064). In an embodiment herein, a convolution layer with fusion weights (1072) is generated, wherein the fusion wights are obtained using weights for 3*3 convolution for directional interpolation (1066) and weights for 3*3 convolution for gradient computation (1069). A convolution layer with output as directional interpolated features (1068), a convolution layer with output as gradient features (1070), and the convolution layer with fusion weights (1072) are fed by the combination module (1056) to a transfer DNN demosaic model (1074) in order to obtain a device optimal demosaic model (1075).

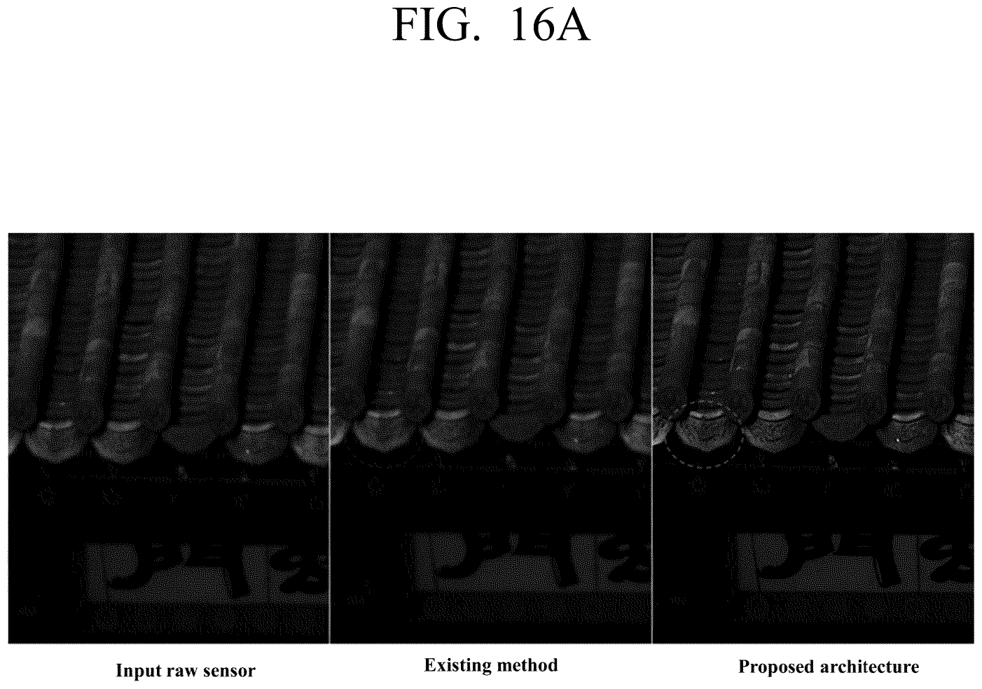

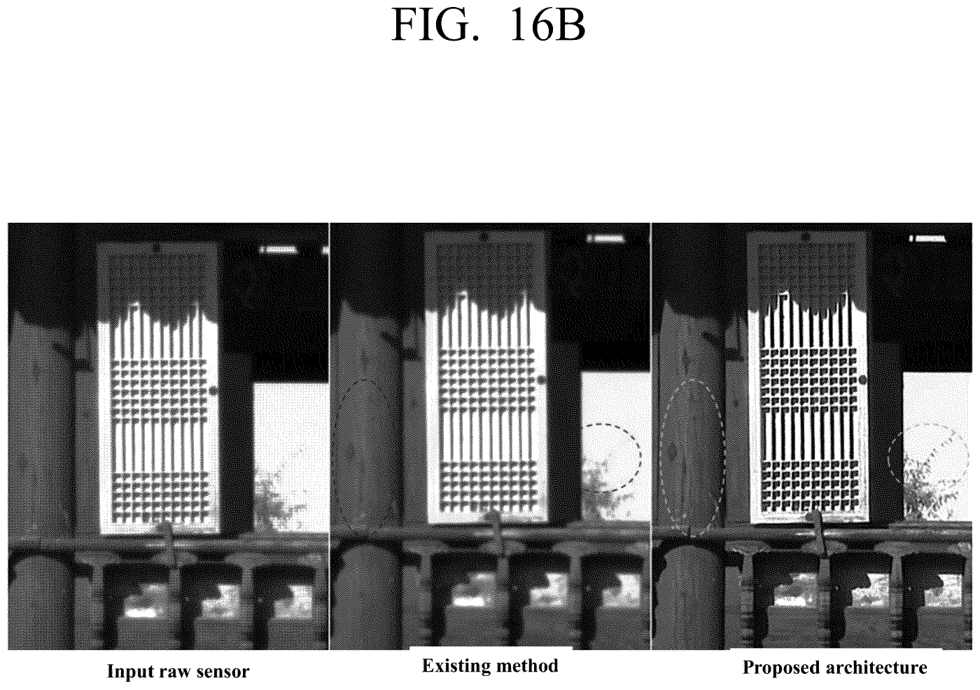

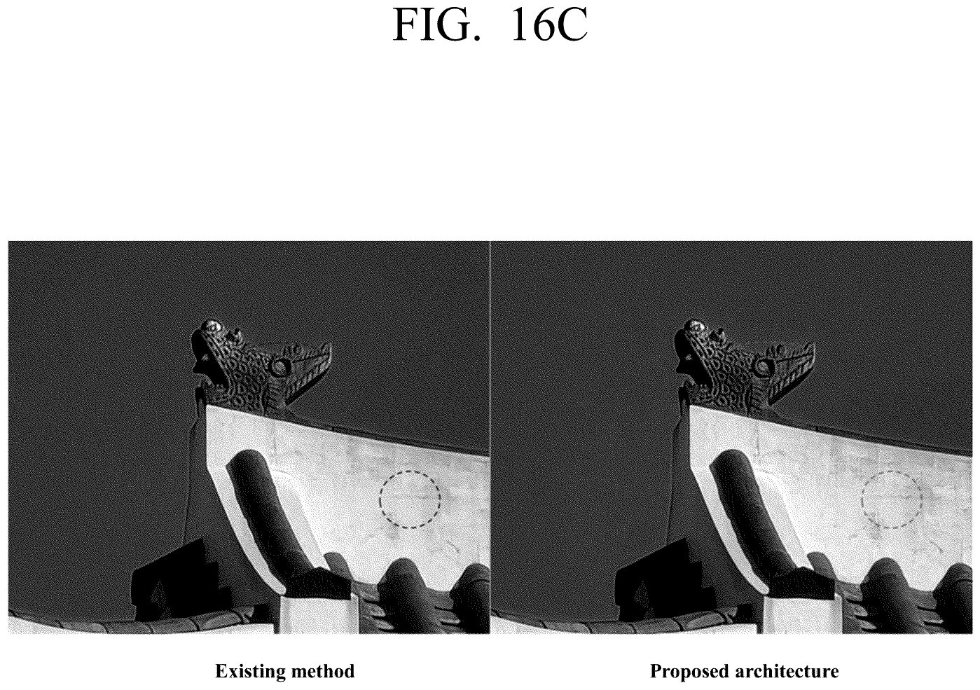

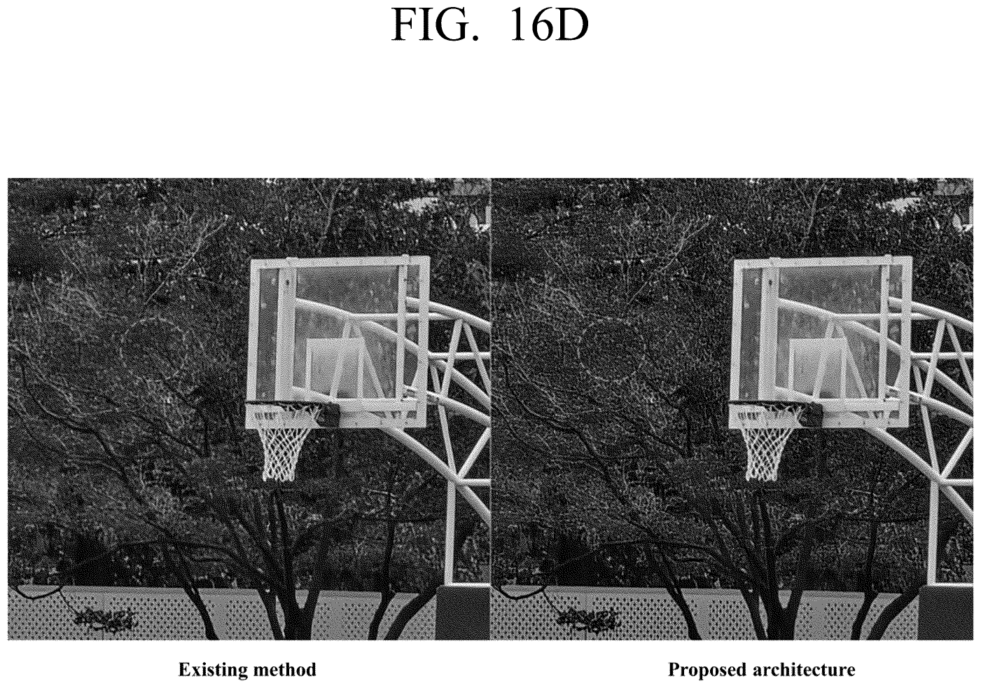

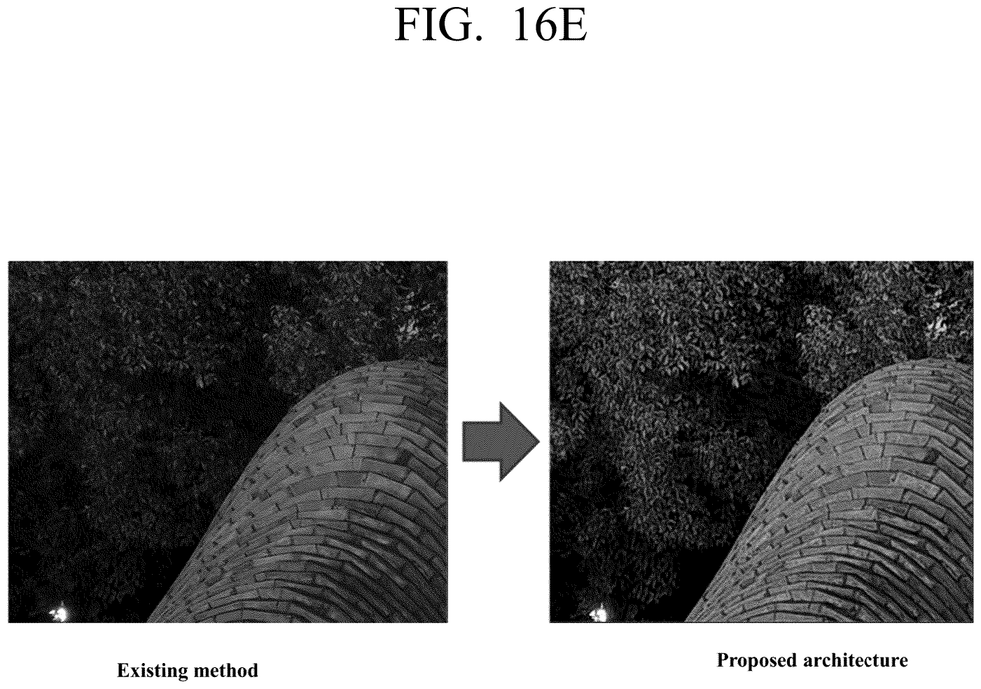

FIG. 16A depicts an example high scale zoom capture (10×-100×). Fine details observed in captured image using proposed demosaic architecture according to an embodiment of the disclosure.

FIG. 16B depicts an alternate example high scale zoom capture (10×-100×). Natural texture retention is observed in captured image using proposed demosaic architecture according to an embodiment of the disclosure.

FIG. 16C depicts an example high resolution capture (50 MP). It can be seen that better details are reproduced in the captured image using the proposed architecture according to an embodiment of the disclosure.

FIG. 16D depicts an alternate example high resolution capture (50 MP). Better natural texture, and leaves in image are captured using the proposed architecture according to an embodiment of the disclosure.

FIG. 16E depicts a tetra zoom (10×-100×)capture according to an embodiment of the disclosure. Embodiments herein can replace the current demosaic model in tetra zoom (10×-100×).

Embodiments herein provide a demosaic architecture using position dependent interpolation, position aware gradient, and light weight AI demosaic model for non-Bayer CFAs. Embodiments herein provide a schematic for position dependent interpolation, and position aware gradient for filtering maximum information to a light weight AI deep neural network (DNN) demosaic model. Embodiments herein provide an on device architecture of conditioning layer for faster execution on compute element (neural processing unit (NPU), graphics processing unit (GPU)). Embodiments herein disclose, high quality demosaic output from raw non-Bayer CFA without suffering from loss of details, texture and resolution power while maintaining low inference time (˜200 ms for 12 MP).

Embodiments herein provide a method for demosaicing a non-Bayer CFA image data. The method comprises receiving as input, non-Bayer CFA from an image sensor. The CFA includes a plurality of pixel blocks each having multiple colors of RGB, and a plurality of sub-blocks each having uniform color. Each sub-block is a sub-set of the pixel block. The method comprises identifying in the non-Bayer CFA, recurrent pixel blocks those following a common pixel pattern at block level and uniform color pattern at sub-block level. The method comprises estimating for each recurrent pixel block, a position dependent directional interpolation for computing missing colors for each pixel in the recurring block, wherein a direction of neighboring pixels, number of neighboring pixels, and their corresponding weights required for interpolation are determined based on position of each pixel within the recurring block. The method comprises estimating for each recurrent block, a position aware gradient for computing the rate of change of color for each pixel in the recurring block, wherein a direction of neighboring pixels, number of neighboring pixels and their corresponding weights to be used for gradient computation based on position, and color of each pixel within the recurring block. Thereafter, the method comprises generating an output RGB image data by feeding the non-Bayer CFA, estimated position dependent directional interpolation, and the estimated position aware gradient using a light weight demosaic artificial intelligence (AI) model. The characteristics/advantages of the proposed demosaic architecture include:
Light weight demosaic model can learn the solution space effectively due to directional interpolation and gradient prior.
Unique schematic of directional interpolation and gradient computation enabling very fast execution on device (4-5 ms) for 12 MP.
Better details, texture retention and resolution power as compared to traditional methods.

Embodiments herein solve the problem of real time light weight non-Bayer CFA AI demosaic through a novel architecture which leverages a position dependent interpolation, a position aware gradient, and a light weight AI demosaic model. In addition, proposed conditioning layer is designed in such a way that it can be executed on NPU in 3-4 ms for 12 MP sensing thus making solution efficient and realizable.

Embodiments herein disclose an on-device computation friendly architecture for position dependent interpolation, and position aware gradient. Embodiments herein are a schematic of directional interpolation for non-Bayer CFA, and a schematic of position aware gradient computation for non-Bayer CFA. Embodiments herein provide conditioning of a light weight demosaic model with directional interpolation, a position aware gradient and their combination for high quality demosaic of non-Bayer CFA.

Embodiments herein provide a peak signal-to-noise ratio (PSNR) gain over light weight demosaic model trained with zero or no interpolation, fine detail retention in captured scene, fine texture reproduction in captured scene, and better color consistency in captured image. Example use cases include high scale camera zoom, high resolution image capture in camera pipeline, and a real time video ISP. Embodiments herein provide a demosaic architecture which produces high quality demosaic output from non-Bayer CFA without suffering from loss of details, texture, and resolution power while maintaining low inference time.

The embodiments disclosed herein can be implemented through at least one software program running on at least one hardware device and performing network management functions to control the elements. The elements can be at least one of a hardware device, or a combination of hardware device and software module.

The embodiment disclosed herein describes method(s) and system(s) for demosaicing a non-Bayer color filter array (CFA). Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for demosaicing a non-Bayer color filter array (CFA) image data performed by an electronic device, the method comprising:
receiving as input, by at least one processor of the electronic device, non-Bayer CFA image data from an image sensor of the electronic device, the non-Bayer CFA image data including a plurality of pixel blocks with individual pixel block having multiple colors of red, green, blue (RGB), and a plurality of sub-blocks with individual sub-block having uniform color, and each sub-block being a sub-set of the pixel block;
identifying, by the at least one processor, in the non-Bayer CFA image data, at least one recurrent pixel block following a common pixel pattern at a block level and a uniform color pattern at a sub-block level;
estimating, by the at least one processor, for the at least one recurrent pixel block, a position dependent directional interpolation for computing a plurality of missing colors for each pixel in the at least one recurrent pixel block, based on, a number of neighboring pixels to the each pixel of the at least one recurrent pixel block, a direction of the neighboring pixels, and corresponding weights of interpolation for the number of neighboring pixels;
generating, by the at least one processor, a position dependent interpolation feature map using the estimated position dependent directional interpolation;
estimating, by the at least one processor, for the at least one recurrent pixel block, a position aware gradient for computing a rate of change of color for each pixel in the at least one recurrent pixel block, based on a number of neighboring pixels to the each pixel of the at least one recurrent pixel block, a direction of the neighboring pixels, and corresponding weights of gradient computation for the number of neighboring pixels;
generating, by the at least one processor, a position aware gradient feature map using the estimated position aware gradient; and
generating, by the at least one processor, an output RGB image data using a demosaic artificial intelligence (AI) model, by feeding the generated position dependent interpolation feature map, and the generated position aware gradient feature map, and the non-Bayer CFA image data.

2. The method as claimed in claim 1, wherein the corresponding weights for directional interpolation for the number of neighboring pixels to each pixel of the at least one recurrent pixel block is determined based on at least, relative position of each pixel in the at least one recurrent pixel block, and the number and position of neighboring pixels.

3. The method as claimed in claim 1, wherein the corresponding weights for gradient computation for the number of neighboring pixels to each pixel of the at least one recurrent pixel block is determined based on, at least:
relative position of each pixel in the at least one recurrent pixel block, and the number and position of neighboring pixels,
color of each pixel of the at least one recurrent pixel block, and
relative color difference between, each pixel at the sub-block level in the at least one recurrent pixel block, and the number of neighboring pixels having uniform color, as each pixel at the sub-block level in the at least one recurrent pixel block.

4. The method as claimed in claim 1, further comprising:
identifying, by the at least one processor, in the non-Bayer CFA pattern image data, a plurality of recurrent pixel blocks following a repeating pattern at a fixed block and a uniform color pattern at the plurality of sub-blocks.

5. The method as claimed in claim 1, further comprising:
generating, by the at least one processor, a non-Bayer feature map including feature of the non-Bayer CFA pattern image data,
wherein the non-Bayer CFA pattern image data includes a plurality of repeating patterns of a fixed block having multiple RGB color pixels, and a plurality of pre-defined number of sub-blocks present within the fixed block, and
wherein individual sub-block of the plurality of sub-blocks has uniform color pixel.

6. The method as claimed in claim 5, further comprising:
estimating, by the at least one processor, a plurality of missing colors for the each pixel in the non-Bayer feature map, and
wherein the estimating of the plurality of missing color includes:
identifying, by the at least one processor, a plurality of uniform color pixels of at least, a sub-block present within a fixed bock of the non-Bayer feature map;
interpolating, by the at least one processor, for each pixel in the identified sub-block, a plurality of missing RGB color pixels, in a plurality of neighboring sub-blocks associated with a plurality of neighboring fixed blocks of the non-Bayer feature map, using the position dependent directional interpolation for each pixel;
determining, by the at least one processor, with respect to the each pixel of the identified sub-block, a direction of interpolation, corresponding to the plurality of neighboring sub-blocks;
determining, by the at least one processor, with respect to the each pixel of the identified sub-block, a total number of the plurality of neighboring sub-blocks; and
assigning, by the at least one processor, a plurality of weights to each pixel in the plurality of neighboring sub-blocks.

7. The method as claimed in claim 6, wherein the direction of interpolation, the total number of the plurality of neighboring sub-blocks, and the assigned plurality of weights to each pixels in the plurality of neighboring sub-blocks are determined based on, at least one of:
a relative position of each pixel in the identified sub-block and a plurality of RGB color pixels, in the plurality of neighboring sub-blocks, or
a color of each pixel in the identified sub-block and a color of each pixel, in the plurality of neighboring sub-blocks.

8. The method as claimed in claim 5, wherein the estimating of the rate of change of color for each pixel in the non-Bayer feature map, includes:
identifying, by the at least one processor, a plurality of uniform color pixels of at least one sub-block present within a fixed bock of the non-Bayer feature map;
estimating, by the at least one processor, the rate of change of color, for each pixel in the identified sub-block, with respect to a plurality of RGB color pixels in a plurality of neighboring sub-blocks associated with a plurality of neighboring fixed blocks of the non-Bayer feature map, using the position aware gradient for each pixel;
determining, by the at least one processor, with respect to the each pixel of the identified sub-block, a direction of estimation for the rate of change of color, with respect to the plurality of neighboring sub-blocks;
determining, by the at least one processor, with respect to the each pixel of the identified sub-block, a total number of the plurality of neighboring sub-blocks; and
assigning, by the at least one processor, a plurality of weights to each pixel in the plurality of neighboring sub-blocks.

9. The method as claimed in claim 8, wherein the direction of estimation, the total number of the plurality of neighboring sub-blocks and the assigned plurality of weights to each pixels in the plurality of neighboring sub-blocks are determined based on, at least one of:
a relative position of the pixel in the identified sub-block and a plurality of RGB color pixels, in the plurality of neighboring sub-blocks, and
a color of the pixel in the identified sub-block and a color of each pixel, in the plurality of neighboring sub-blocks.

10. The method as claimed in claim 1, wherein the generating of the output RGB image data further includes:
generating, by the at least one processor, a gradient normalized interpolation feature map by fusing the position dependent interpolation feature map and the position aware gradient feature map of the non-Bayer CFA image data; and
feeding, by the at least one processor, the non-Bayer CFA image data, the position dependent interpolation feature map, the position aware gradient feature map, and the gradient normalized interpolation feature map to the demosaic AI model.

11. An electronic device, comprising:
an image sensor;
memory storing instructions; and
at least one processor communicatively coupled to the image sensor and the memory,
wherein the instructions, when executed by the at least one processor individually or collectively, cause the electronic device to:
receive as input, non-Bayer color filter array (CFA) image data from the image sensor, the CFA image data including a plurality of pixel blocks with individual pixel block having multiple colors of red, green, blue (RGB) and a plurality of sub-blocks with individual sub-block having uniform color, and each sub-block being a sub-set of the pixel block,
identify, in the non-Bayer CFA image data, at least one recurrent pixel block following a common pixel pattern at a block level and a uniform color pattern at a sub-block level,
estimate, for the at least one recurrent pixel block, a position dependent directional interpolation for computing a plurality of missing colors for each pixel in the at least one recurrent pixel block, based on, a number of neighboring pixels to the each pixel of the at least one recurrent pixel block, a direction of the neighboring pixels, and corresponding weights of interpolation for the number of neighboring pixels,
generate a position dependent interpolation feature map using the estimated position dependent directional interpolation,
estimate, for the at least one recurrent pixel block, a position aware gradient for computing a rate of change of color for each pixel in the at least one recurrent pixel block, based on a number of neighboring pixels to the each pixel of the at least one recurrent pixel block, a direction of the neighboring pixels, and corresponding weights of gradient computation for the number of neighboring pixels,
generate a position aware gradient feature map using the estimated position aware gradient, and
generate, an output RGB image data using a demosaic artificial intelligence (AI) model, by feeding the generated position dependent interpolation feature map, and the generated position aware gradient feature map, and the non-Bayer CFA image data.

12. The electronic device as claimed in claim 11, wherein the corresponding weights for directional interpolation for the number of neighboring pixels to each pixel of the at least one recurrent pixel block is determined based on at least, relative position of each pixel in the at least one recurrent pixel block, and the number and position of neighboring pixels.

13. The electronic device as claimed in claim 11, wherein the corresponding weights for gradient computation for the number of neighboring pixels to each pixel of the at least one recurrent pixel block is determined based on, at least:
relative position of each pixel in the at least one recurrent pixel block and, the number and position of neighboring pixels,
color of each pixel of the, at least one recurrent pixel block, and
relative color difference between, each pixel at the sub-block level in the at least one recurrent pixel block, and the number of neighboring pixels having uniform color, as each pixel at the sub-block level in the at least one recurrent pixel block.

14. The electronic device as claimed in claim 11, wherein the instructions, when executed by the at least one processor individually or collectively, further cause the electronic device to:
identify, in the non-Bayer CFA pattern image data, a plurality of recurrent pixel blocks following a repeating pattern at a fixed block and a uniform color pattern at the plurality of sub-blocks.

15. The electronic device as claimed in claim 11,
wherein the instructions, when executed by the at least one processor individually or collectively, further cause the electronic device to:
generate a non-Bayer feature map including feature of the non-Bayer CFA pattern image data,
wherein the non-Bayer CFA pattern image-data includes a plurality of repeating patterns of a fixed block having multiple RGB color pixels, and a plurality of pre-defined number of sub-blocks present within the fixed block, and
wherein individual sub-block of the plurality of sub-blocks has uniform color pixel.

16. The electronic device as claimed in claim 15,
wherein the instructions, when executed by the at least one processor individually or collectively, further cause the electronic device to:
estimate a plurality of missing colors for the each pixel in the non-Bayer feature map, and
wherein, to estimate of the plurality of missing color, the instructions, when executed by the at least one processor individually or collectively, further cause the electronic device to:
identify, a plurality of uniform color pixels of at least, a sub-block present within a fixed bock of the non-Bayer feature map,
interpolate, for each pixel in the identified sub-block, a plurality of missing RGB color pixels, in a plurality of neighboring sub-blocks associated with a plurality of neighboring fixed blocks of the non-Bayer feature map, using the position dependent directional interpolation for each pixel,
determine, with respect to the each pixel of the identified sub-block, a direction of interpolation, corresponding to the plurality of neighboring sub-blocks,
determine, with respect to the each pixel of the identified sub-block, a total number of the plurality of neighboring sub-blocks, and
assign, a plurality of weights to each pixel in the plurality of neighboring sub-blocks.

17. The electronic device as claimed in claim 16, wherein the direction of interpolation, the total number of the plurality of neighboring sub-blocks, and the assigned plurality of weights to each pixels in the plurality of neighboring sub-blocks are determined based on, at least one of:
a relative position of each pixel in the identified sub-block and a plurality of RGB color pixels, in the plurality of neighboring sub-blocks, or
a color of each pixel in the identified sub-block and a color of each pixel, in the plurality of neighboring sub-blocks.

18. The electronic device as claimed in claim 15, wherein, to estimate the rate of change of color for each pixel in the non-Bayer feature map, the instructions, when executed by the at least one processor individually or collectively, further cause the electronic device to:
identify, a plurality of uniform color pixels of at least one sub-block present within a fixed bock of the non-Bayer feature map;
estimate, the rate of change of color, for each pixel in the identified sub-block, with respect to a plurality of RGB color pixels in a plurality of neighboring sub-blocks associated with a plurality of neighboring fixed blocks of the non-Bayer feature map, using the position aware gradient for each pixel;
determine, with respect to the each pixel of the identified sub-block, a direction of estimation for the rate of change of color, with respect to the plurality of neighboring sub-blocks;
determine, with respect to the each pixel of the identified sub-block, a total number of the plurality of neighboring sub-blocks; and
assign a plurality of weights to each pixel in the plurality of neighboring sub-blocks.

19. One or more non-transitory computer-readable storage media storing instructions that, when executed by at least one processor of an electronic device individually or collectively, cause the electronic device to perform operations, the operations comprising:
receiving as input, by the at least one processor, non-Bayer color filter array (CFA) image data from an image sensor of the electronic device, the non-Bayer CFA image data including a plurality of pixel blocks with individual pixel block having multiple colors of red, green, blue (RGB), and a plurality of sub-blocks with individual sub-block having uniform color, and each sub-block being a sub-set of the pixel block;
identifying, by the at least one processor, in the non-Bayer CFA image data, at least one recurrent pixel block following a common pixel pattern at a block level and a uniform color pattern at a sub-block level;
estimating, by the at least one processor, for the at least one recurrent pixel block, a position dependent directional interpolation for computing a plurality of missing colors for each pixel in the at least one recurrent pixel block, based on, a number of neighboring pixels to the each pixel of the at least one recurrent pixel block, a direction of the neighboring pixels, and corresponding weights of interpolation for the number of neighboring pixels;
generating, by the at least one processor, a position dependent interpolation feature map using the estimated position dependent directional interpolation;
estimating, by the at least one processor, for the at least one recurrent pixel block, a position aware gradient for computing a rate of change of color for each pixel in the at least one recurrent pixel block, based on a number of neighboring pixels to the each pixel of the at least one recurrent pixel block, a direction of the neighboring pixels, and corresponding weights of gradient computation for the number of neighboring pixels;
generating, by the at least one processor, a position aware gradient feature map using the estimated position aware gradient; and
generating, by the at least one processor, an output RGB image data using a demosaic artificial intelligence (AI) model, by feeding the generated position dependent interpolation feature map, and the generated position aware gradient feature map, and the non-Bayer CFA image data.

20. The one or more non-transitory computer-readable storage media of claim 19, wherein the corresponding weights for directional interpolation for the number of neighboring pixels to each pixel of the at least one recurrent pixel block is determined based on at least, relative position of each pixel in the at least one recurrent pixel block, and the number and position of neighboring pixels.
